(19) United States
(12) Patent Application Publication
(10) Pub. No.: US 2015/0350671 A1
(43) Pub. Date: Dec. 3, 2015

(54) MOTION COMPENSATION METHOD AND DEVICE FOR ENCODING AND DECODING SCALABLE VIDEO

(71) Applicant: SAMSUNG ELECTRONICS CO., LTD., Suwon-si Gyeonggi-do (KR)

(72) Inventors: Alexander ALSHIN, Suwon-si (KR); Elena ALSHINA, Suwon-si (KR)

(73) Assignee: SAMSUNG ELECTRONICS CO., LTD., Suwon-si (KR)

(21) Appl. No.: 14/759,322

(22) PCT Filed: Jan. 6, 2014
(86) PCT No.: PCT/KR2014/000109

§ 371 Date: Jul. 6, 2015

Related U.S. Application Data
(60) Provisional application No. 61/748,899, filed on Jan. 4, 2013.

(51) Int. Cl. H04N 19/577; H04N 19/105; H04N 19/13; H04N 19/176; H04N 19/187; H04N 19/31; H04N 19/124; H04N 19/137

(52) U.S. Cl. CPC H04N 19/577; H04N 19/124; H04N 19/105; H04N 19/137; H04N 19/176; H04N 19/187; H04N 19/31; H04N 19/13

(57) ABSTRACT

Provided is a motion compensation method for encoding and decoding a scalable video. A first prediction value of pixels constituting a current block is acquired from a corresponding block of a base layer corresponding to the current block of an enhancement layer, a second prediction value of the pixels constituting the current block is acquired by using a block-unit bidirectional motion compensation result and a pixel-unit motion compensation result about the enhancement layer, and a prediction value of the pixels constituting the current block is acquired by using a weighted sum of the first prediction value and the second prediction value.

### CROSS-REFERENCE TO RELATED APPLICATIONS

This application is a National Stage application under 35 U.S.C. §371 of PCT/KR2014/000109, filed on Jan. 6, 2014, which claims priority from U.S. Provisional Application 61/748,899, filed on Jan. 4, 2013 in the United States Patent and Trademark Office, all the disclosures of which are incorporated herein in their entireties by reference.

### BACKGROUND

1. Field

Apparatuses and methods consistent with exemplary embodiments relate to video encoding and decoding, and more particularly, to processes of generating prediction values by performing accurate bidirectional motion compensation on scalable videos.

2. Description of the Related Art

In general, image data is encoded according to a predetermined data compression standard such as Moving Picture Expert Group (MPEG), and the encoded image data is stored in an information storage medium in the form of a bit stream or is transmitted through a communication channel.

Scalable video coding (SVC) is an example of the video compression method for adjusting the amount of information suitably according to various communication networks and terminals prior to transmission. In the SVC, encoded videos of various layers are included in one bit stream so that services may be adaptively provided through various transmission networks and various receiving terminals.

In the related art SVC, videos are encoded according to predetermined encoding methods based on macro-blocks of predetermined sizes.

### SUMMARY

Aspects of one or more exemplary embodiments provide prediction values that are acquired more accurately by performing pixel-unit accurate motion compensation when generating prediction values by bidirectional motion compensation on blocks of each layer in scalable video encoding and decoding processes.

According to aspects of one or more exemplary embodiments, a pixel-unit displacement motion vector of an upper-layer image is determined by using lower-layer image data and upper-layer image data of a scalable video, and a more accurate prediction value is acquired by performing accurate bidirectional motion compensation on the upper-layer image.

According to aspects of one or more exemplary embodiments, prediction efficiency is improved by performing pixel-unit accurate bidirectional motion compensation without separate information by using information of reference pictures. Also, according to one or more exemplary embodiments, accurate bidirectional motion compensation may be performed on an enhancement-layer image by using a base-layer image.

According to an aspect of an exemplary embodiment, there is provided a motion compensation method for encoding and decoding a scalable video includes: acquiring a first prediction value of pixels constituting a current block from a corresponding block of a base layer corresponding to the current block of an enhancement layer; acquiring a first motion vector indicating a first corresponding block of a first reference picture referenced by the current block and a second motion vector indicating a second corresponding block of a second reference picture referenced by the current block; performing block-unit bidirectional motion compensation on the current block by using the first motion vector and the second motion vector; performing pixel-unit motion compensation on each pixel of the current block by using pixels of the first reference picture and the second reference picture; acquiring a second prediction value of the pixels constituting the current block by using the block-unit bidirectional motion compensation results and the pixel-unit motion compensation results; and acquiring a prediction value of the pixels constituting the current block by using a weighted sum of the first prediction value and the second prediction value.

According to an aspect of another exemplary embodiment, there is provided a motion compensation device for encoding and decoding a scalable video includes: a lower-layer prediction information acquiring unit configured to acquire a first prediction value of pixels constituting a current block from a corresponding block of a base layer corresponding to the current block of an enhancement layer; a block-unit motion compensation unit configured to acquire a first motion vector indicating a first corresponding block of a first reference picture referenced by the current block and a second motion vector indicating a second corresponding block of a second reference picture referenced by the current block and perform block-unit bidirectional motion compensation on the current block by using the first motion vector and the second motion vector; a pixel-unit motion compensation unit configured to perform pixel-unit motion compensation on each pixel of the current block by using pixels of the first reference picture and the second reference picture and acquire a second prediction value of the pixels constituting the current block by using the block-unit bidirectional motion compensation results and the pixel-unit motion compensation results; and a prediction value generating unit configured to acquire a prediction value of the pixels constituting the current block by using a weighted sum of the first prediction value and the second prediction value.

### DESCRIPTION OF THE DRAWINGS

The above and other features and advantages of the present invention will become more apparent by describing in detail exemplary embodiments thereof with reference to the attached drawings in which:

FIG. 1 is a block diagram of a video encoding apparatus according to an exemplary embodiment;

FIG. 2 is a block diagram of a video decoding apparatus according to an exemplary embodiment;

FIG. 3 illustrates the concept of a coding unit according to an exemplary embodiment;

FIG. 4 is a block diagram of an image coding unit based on a coding unit according to an exemplary embodiment;

FIG. 5 is a block diagram of an image decoding unit based on a coding unit according to an exemplary embodiment;

FIG. 6 illustrates depth-by-depth coding units and partitions according to an exemplary embodiment;

FIG. 7 illustrates the relationship between a coding unit and a transformation unit according to an exemplary embodiment;

FIG. 8 illustrates depth-by-depth encoding information according to an exemplary embodiment;

FIG. 9 illustrates depth-by-depth coding units according to an exemplary embodiment;

FIGS. 10, 11, and 12 illustrate the relationship between a coding unit, a prediction unit, and a frequency transformation unit according to an exemplary embodiment;

FIG. 13 illustrates the relationship between a coding unit, a prediction unit, and a transformation unit according to encoding mode information of Table 1;

FIG. 14 is a block diagram of a scalable video encoding apparatus 1400 according to an exemplary embodiment;

FIG. 15 is a block diagram of a scalable video decoding apparatus according to an exemplary embodiment;

FIG. 16 is a block diagram of a scalable encoding apparatus 1600 according to an exemplary embodiment;

FIG. 17 is a block diagram of a scalable decoding apparatus 2400 according to an exemplary embodiment;

FIG. 18 is a block diagram of a motion compensation unit according to an exemplary embodiment;

FIG. 19 is a block diagram of a motion compensation unit according to another exemplary embodiment;

FIG. 20 is a reference diagram illustrating block-based bidirectional motion prediction and compensation processes according to an exemplary embodiment;

FIG. 21 is a reference diagram illustrating a process of performing pixel-unit motion compensation according to an exemplary embodiment;

FIG. 22 is a reference diagram illustrating a process of calculating horizontal and vertical gradient values according to an exemplary embodiment;

FIG. 23 is a reference diagram illustrating a process of calculating horizontal and vertical gradient values according to another exemplary embodiment;

FIG. 24 is a reference diagram illustrating a process of determining a horizontal displacement vector and a vertical displacement vector according to an exemplary embodiment; and

FIG. 25 is a flowchart illustrating a motion compensation method for scalable video encoding and decoding according to an exemplary embodiment.

### DETAILED DESCRIPTION OF EXEMPLARY EMBODIMENTS

Hereinafter, exemplary embodiments will be described in detail with reference to the accompanying drawings. In the description, like reference numbers refer to like elements throughout. As used herein, the term “and/or” includes any and all combinations of one or more associated items. Expressions such as “at least one of,” when preceding a list of elements, modify the entire list of elements and do not modify the individual elements of the list.

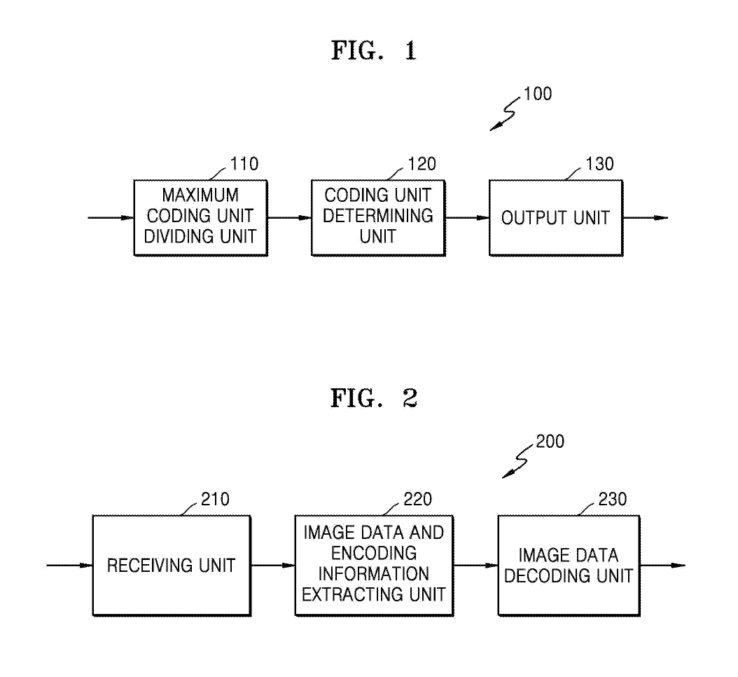

FIG. 1 is a block diagram of a video encoding apparatus 100 according to an exemplary embodiment.

A video encoding apparatus 100 according to an exemplary embodiment includes a maximum coding unit dividing unit 110 (e.g., maximum coding unit divider), a coding unit determining unit 120 (e.g., coding unit determiner), and an output unit 130 (e.g., outputter or output device).

The maximum coding unit dividing unit 110 may divide a current picture based on a maximum coding unit that is a coding unit of a maximum size for the current picture of an image. When the current picture is larger than the maximum coding unit, image data of the current picture may be divided into at least one maximum coding unit. The maximum coding unit according to an exemplary embodiment may be a data unit having a size of 32×32, 64×64, 128×128, 256×256, or the like, and may be a square data unit having a horizontal and vertical size of the square of 2 that is greater than 8. The image data may be output to the coding unit determining unit 120 for each of at least one maximum coding unit.

The coding unit according to an exemplary embodiment may be defined by the maximum size and depth. The depth may represent the frequency of spatial division of the coding unit from the maximum coding unit, and the depth-by-depth coding unit may be divided from the maximum coding unit into the minimum coding unit as the depth increases. The depth of the maximum coding unit may be the highest depth, and the minimum coding unit may be defined as the lowest coding unit. Since the size of the depth-by-depth coding unit decreases with the increase in the depth of the maximum coding unit, the higher-depth coding unit may include a plurality of lower-depth coding units.

As described above, the image data of the current picture may be divided into maximum coding units according to the maximum size of the coding unit, and each of the maximum coding units may include coding units that are divided on a depth-by-depth basis. Since the maximum coding unit according to an exemplary embodiment is divided on a depth-by-depth basis, spatial-domain image data included in the maximum coding unit may be hierarchically classified according to the depths.

The maximum size of the coding unit and the maximum depth defining the total frequency of hierarchical division of the height and width of the maximum coding unit may be preset.

The coding unit determining unit 120 may encode at least one division region into which the region of the maximum coding unit is divided for each depth, and determine the depth by which the final encoding result is to be output for each of at least one division region. That is, the coding unit determining unit 120 encodes the image data by the depth-by-depth coding unit for each maximum coding unit of the current picture, selects the depth causing the smallest encoding error, and determines the selected depth as the encoding depth. The determined encoding depth and the image data for each maximum coding unit are output to the output unit 130.

The image data in the maximum coding unit is encoded based on the depth-by-depth coding unit according to at least one depth that is lower than or equal to the maximum depth, and the encoding results based on each depth-by-depth coding unit are compared. The depth having the smallest encoding error may be selected as a result of the comparison between the encoding errors of the depth-by-depth coding units. At least one encoding depth may be determined for each maximum coding unit.

As for the size of the maximum coding unit, with the increase in the depth, the coding unit is hierarchically divided and the number of coding units increases. Also, even in the case of the same-depth coding units included in one maximum coding unit, the encoding error for each data is measured and whether to divide into the lower depth is determined.

Thus, even in the case of the data included in one maximum coding unit, since the depth-by-depth encoding errors differ according to positions, the encoding depths may be determined differently according to positions. Thus, one or more encoding depths may be set for one maximum coding unit, and the data of the maximum coding unit may be divided according to the coding units of one or more encoding depths.

Thus, the coding unit determining unit 120 according to an exemplary embodiment may determine the coding units according to a tree structure included in the current maximum coding unit. The ‘coding units according to a tree structure’ according to an exemplary embodiment include the coding units of the depth determined as the encoding depth, among all the depth-by-depth coding units included in the current maximum coding unit. The coding units of the encoding depths may be hierarchically determined according to the depths in the same region in the maximum coding unit and may be independently determined in other regions. Likewise, the encoding depths for the current region may be determined independently from the encoding depths for other regions.

The maximum depth according to an exemplary embodiment is an index related to the frequency of division from the maximum coding unit to the minimum coding unit. The first maximum depth according to an exemplary embodiment may represent the total frequency of division from the maximum coding unit to the minimum coding unit. The second maximum depth according to an exemplary embodiment may represent the total number of depth levels from the maximum coding unit to the minimum coding unit. For example, when the depth of the maximum coding unit is 0, the depth of the coding unit generated by one-time division from the maximum coding unit may be set to 1 and the depth of the coding unit generated by two-time division from the maximum coding unit may be set to 2. In this case, when the coding unit generated by four-time division from the maximum coding unit is the minimum coding unit, since four depth levels of depths 0, 1, 2, 3, and 4 exist, the first maximum depth may be set to 4 and the second maximum depth may be set to 5.

Frequency transformation and prediction encoding of the maximum coding unit may be performed. Likewise, prediction encoding and frequency transformation may also be performed based on the depth-by-depth coding units for each maximum coding unit and for each depth that is lower than or equal to the maximum depth.

Whenever the maximum coding unit is divided on a depth-by-depth basis, the number of depth-by-depth coding units increases. Therefore, encoding including prediction encoding and frequency transformation should be performed on all the depth-by-depth coding units generated according to the increase of the depth. Hereinafter, for convenience of description, prediction encoding and frequency transformation will be described based on the coding unit of the current depth among at least one maximum coding unit.

The video encoding apparatus 100 according to an exemplary embodiment may variously select the size or type of a data unit for encoding of the image data. Operations such as prediction encoding, frequency transformation, and entropy encoding may be performed for encoding of the image data. In this case, the same data unit may be used throughout all the operations, or the data unit may change on an operation-by-operation basis.

For example, the video encoding apparatus 100 may not only select a coding unit for encoding of the image data, but also select a data unit different from the coding unit in order to perform prediction encoding of the image data of the coding unit.

For prediction encoding of the maximum coding unit, the prediction encoding may be performed based on the coding unit of the encoding depth according to an exemplary embodiment, that is, the coding unit that is not divided any more. Hereinafter, the coding unit on which prediction encoding is based and which is not divided any more will be referred to as ‘prediction unit’. The partitions generated by dividing the prediction unit may include the prediction unit and the data unit generated by dividing at least one of the height and width of the prediction unit.

For example, when the coding unit having a size of 2N×2N (where N is a positive integer) is not divided any more, the prediction unit may have a size of 2N×2N and partition sizes may include 2N×2N, 2N×N, N×2N, and N×N. Partition types according to an exemplary embodiment may selectively include not only symmetric partitions generated by dividing the height or width of the prediction unit in a symmetrical ratio, but also partitions generated by division in an asymmetrical ratio such as 1:n or n:1, partitions generated by division into geometrical forms, and partitions of random forms.

A prediction mode of the prediction unit may include at least one of an intra mode, an inter mode, and a skip mode. For example, the intra mode and the inter mode may be performed on 2N×2N, 2N×N, N×2N, and NxN-sized partitions. Also, the skip mode may be performed only on 2N×2N-sized partitions. Encoding may be independently performed on each prediction unit in the coding unit, so that the prediction mode having the smallest encoding error may be selected.

Also, the video encoding apparatus 100 according to an exemplary embodiment may perform frequency transformation of the image data of the coding unit based on not only the coding unit for encoding of the image data but also the data unit different from the coding unit.

For frequency transformation of the coding unit, the frequency transformation may be performed based on the data unit that is smaller than or equal in size to the coding unit. For example, the data unit for frequency transformation may include the data unit for the intra mode and the data unit for the inter mode.

Hereinafter, the data unit on which frequency transformation is based may be referred to as ‘transformation unit’. Similarly to the coding unit, the transformation unit in the coding unit may also be recursively divided into the smaller transformation units, so that the residual data of the coding unit may be divided according to the transformation depth according to the transformation unit according to the tree structure.

Also, for the transformation unit according to an exemplary embodiment, the transformation depth representing the frequency of division from the height and width of the coding unit to the transformation unit may be set. For example, when the size of the transformation unit of the 2N×2N-sized current coding unit is 2N×2N, the transformation depth may be set to 0; when the size of the transformation unit is N×N, the transformation depth may be set to 1; and when the size of the transformation unit is N/2×N/2, the transformation depth may be set to 2. That is, also for the transformation unit, the transformation unit according to the tree structure may be set according to the transformation depth.

The encoding information for each encoding depth includes not only the encoding depth but also prediction-related information and frequency transformation-related information. Thus, the coding unit determining unit 120 may determine not only the encoding depth causing the minimum encoding error, but also the partition type generated by division of the prediction unit into partitions, the prediction mode for each prediction unit, and the size of the transformation unit for frequency transformation.

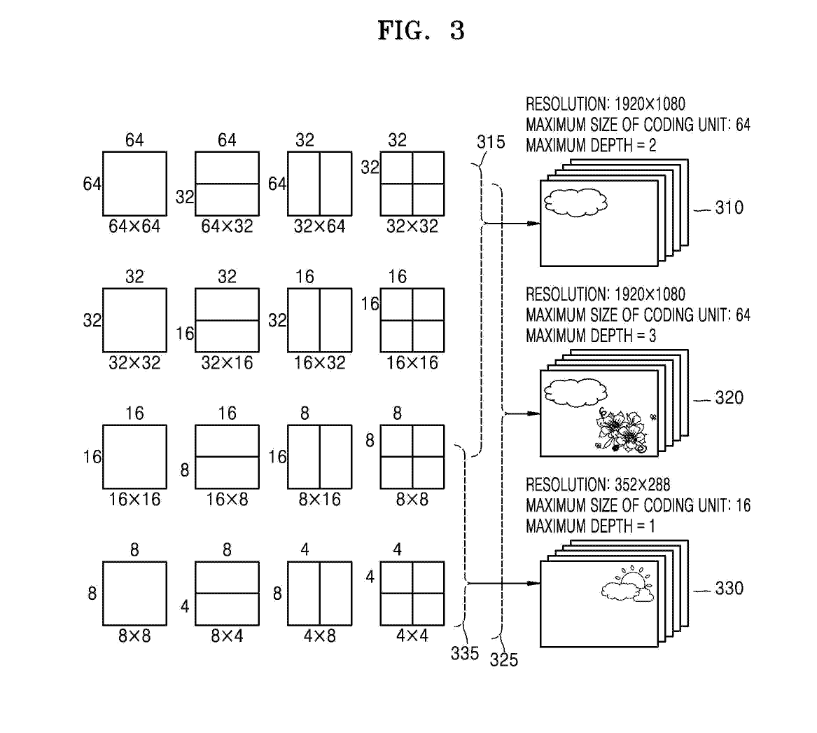

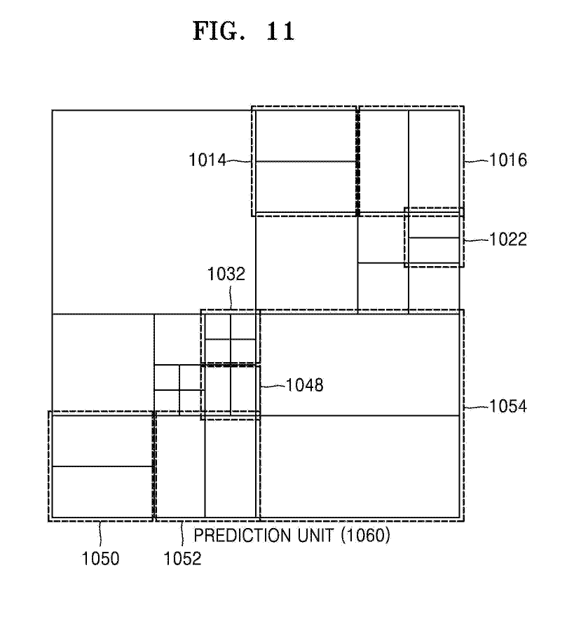

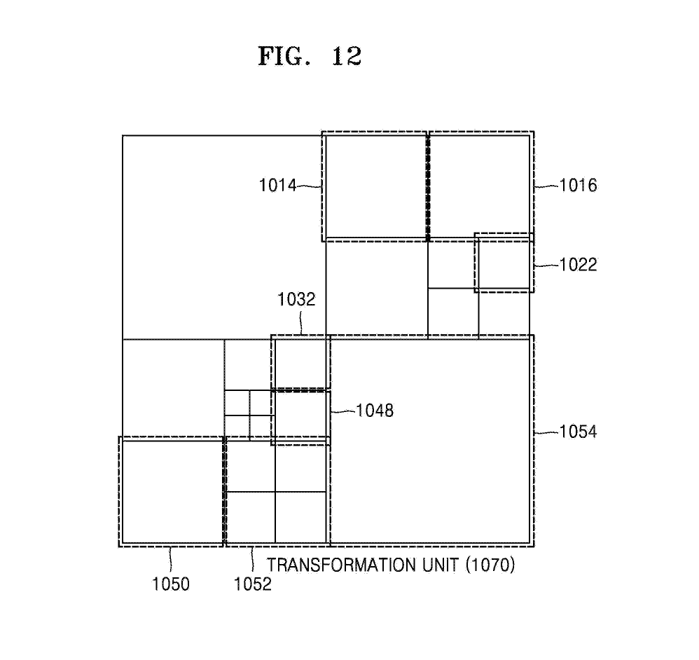

A method of determining the partition and the coding unit according to the tree structure of the maximum coding unit according to one or more exemplary embodiments will be described in detail below with reference to FIGS. 3 to 12.

The coding unit determining unit 120 may measure the encoding error of the depth-by-depth coding unit by using Lagrangian multiplier-based rate-distortion optimization.

The output unit 130 may output information about the depth-by-depth encoding mode and the image data of the maximum coding unit, which are encoded based on at least one encoding depth determined by the coding unit determining unit 120, in the form of a bit stream.

The encoded image data may be the encoding result of the residual data of the image.

The information about the depth-by-depth encoding mode may include encoding depth information, partition type information of the prediction unit, prediction mode information, and size information of the transformation unit.

The encoding depth information may be defined by using depth-by-depth division information indicating whether to perform encoding by the coding unit of the lower depth instead of the current depth. When the current depth of the current coding unit is the encoding depth, since the current coding unit is encoded by the coding unit of the current depth, the division information of the current depth may be defined so as not to be divided by the lower depth any more. On the other hand, when the current depth of the current coding unit is not the encoding depth, since encoding should be attempted by using the coding unit of the lower depth, the division information of the current depth may be defined so as to be divided by the coding unit of the lower depth.

When the current depth is not the encoding depth, encoding is performed on the coding unit divided by the coding unit of the lower depth. Since one or more coding units of the lower depth exist in the coding unit of the current depth, encoding may be repeatedly performed on each coding unit of the lower depth, so that recursive encoding may be performed on each coding unit of the same depth.

Since coding units of the tree structure are determined in one maximum coding unit and information about at least one encoding mode should be determined for each coding unit of the encoding depth, information about at least one encoding mode may be determined for one maximum coding unit. Also, since the data of the maximum coding unit may be hierarchically divided according to the depths and thus the encoding depth may vary on a position-by-position basis, information about the encoding mode and the encoding depth may be set for the data.

Thus, the output unit 130 according to an exemplary embodiment may allocate the encoding information about the encoding mode and the encoding depth for at least one of the minimum unit, the prediction unit, and the coding unit included in the maximum coding unit.

The minimum unit according to an exemplary embodiment may be a square data unit of a size generated by quad-division of the minimum coding unit that is the lowest encoding depth, and may be a square data unit of the maximum size that may be included in the transformation unit, the prediction unit, and any coding unit included in the maximum coding unit.

For example, the encoding information output through the output unit 130 may be classified into encoding information for each depth-by-depth coding unit and encoding information for each prediction unit. The encoding information for each depth-by-depth coding unit may include prediction mode information and partition size information. The encoding information transmitted for each prediction unit may include information about an estimation direction of the inter mode, information about a reference image index of the inter mode, information about a motion vector, information about a chroma component of the intra mode, and information about an interpolation method of the intra mode. Also, information about the maximum depth and information about the maximum size of the coding unit defined for each picture, slice or GOP may be inserted into a header of a bit stream.

According to an exemplary embodiment of the video encoding apparatus 100, the depth-by-depth coding unit is the coding unit of a size generated by halving the height and width of the coding unit of the one-layer higher depth. That is, when the size of the coding unit of the current depth is 2N×2N, the size of the coding unit of the lower depth is NxN. Also, the 2N×2N-sized current coding unit may include up to four N×N-sized lower-depth coding units.

Thus, the video encoding apparatus 100 according to an exemplary embodiment may generate the coding units according to the tree structure by determining the coding unit of the optimum form and size for each maximum coding unit based on the maximum depth and the size of the maximum coding unit determined in consideration of the features of the current picture. Also, since encoding may be performed on each maximum coding unit by various prediction modes and frequency transformation methods, the optimum encoding mode may be determined in consideration of the image features of the coding units of various image sizes.

Thus, when an image of a very high resolution or a very large data amount is encoded by the related art macro-block unit, the number of macro-blocks for each picture increases excessively. Accordingly, since the amount of compressed information generated for each macro-block increases, the transmission load of the compressed information increases and the data compression efficiency tends to decrease. Thus, since the video encoding apparatus according to an exemplary embodiment may adjust the coding unit in consideration of the image features while increasing the maximum size of the coding unit in consideration of the image size, the image compression efficiency may be increased.

FIG. 2 is a block diagram of a video decoding apparatus 200 according to an exemplary embodiment.

A video decoding apparatus 200 according to an exemplary embodiment includes a receiving unit 210 (e.g., receiver), an image data and encoding information extracting unit 220 (e.g., image data and encoding information extractor), and an image data decoding unit 230 (e.g., image data decoder). The definitions of various terms such as information about various encoding modes, transformation units, prediction units, depths, and coding units for various processings of the video decoding apparatus 200 according to an exemplary embodiment are the same as or similar to those described with reference to FIG. 1 and the video encoding apparatus 100.

The receiving unit 210 receives and parses a bit stream of encoded video. The image data and encoding information extracting unit 220 extracts encoded image data for each coding unit according to the coding units according to the tree structure for each maximum coding unit from the parsed bit stream and outputs the same to the image data decoding unit 230. The image data and encoding information extracting unit 220 may extract information about the maximum size of the coding unit of the current picture from a header of the current picture.

Also, the image data and encoding information extracting unit 220 extracts information about the encoding mode and the encoding depth for the coding units according to the tree structure for each maximum coding unit from the parsed bit stream. The extracted information about the encoding mode and the encoding depth is output to the image data decoding unit 230. That is, the image data of the bit stream may be divided by the maximum coding unit, so that the image data decoding unit 230 may decode the image data for each maximum coding unit.

Information about the encoding mode and the encoding depth for each maximum coding unit may be set for one or more encoding depth information, and information about the encoding mode for each encoding depth may include partition type information of the coding unit, prediction mode information, and size information of the transformation unit. Also, depth-by-depth division information may be extracted as encoding depth information.

The information about the encoding mode and the encoding depth for each maximum coding unit, which is extracted by the image data and encoding information extracting unit 220, is information about the encoding mode and the encoding depth that is determined by generating the minimum encoding error by repeatedly performing encoding on each depth-by-depth coding unit for each maximum coding unit by an encoding terminal such as the video encoding apparatus 100 according to an exemplary embodiment. Thus, the video decoding apparatus 200 may restore the image by decoding the data according to the encoding method causing the minimum encoding error.

Since the encoding information about the encoding mode and the encoding depth according to an exemplary embodiment may be allocated for a predetermined data unit among the coding unit, the prediction unit, and the minimum unit, the image data and encoding information extracting unit 220 may extract information about the encoding mode and the encoding depth for each predetermined data unit. When the information about the encoding mode and the encoding depth of the maximum coding unit is recorded for each predetermined data unit, the predetermined data units having the same information about the encoding mode and the encoding depth may be inferred as the data unit included in the same maximum coding unit.

The image data decoding unit 230 may restore the current picture by decoding the image data of each maximum coding unit based on the information about the encoding mode and the encoding depth for each maximum coding unit. That is, the data decoding unit 230 may decode the encoded image data based on the read partition type, prediction mode, and transformation unit for each coding unit among the coding units according to the tree structure included in the maximum coding unit. The decoding process may include a frequency inverse-transformation process and a prediction process including intra-prediction and motion compensation.

The image data decoding unit 230 may perform intra-prediction and motion compensation according to each partition and prediction mode for each coding unit based on the prediction mode information and the partition type information of the prediction unit of the coding unit for each encoding depth.

Also, for frequency inverse-transformation for each maximum coding unit, the image data decoding unit 230 may perform frequency inverse-transformation according to each transformation unit for each coding unit based on the size information of the transformation unit of the coding unit for each encoding depth.

The image data decoding unit 230 may determine the encoding depth of the current maximum coding unit by using the depth-by-depth division information. If the division information indicates no more division in the current depth, the current depth is the encoding depth. Thus, the image data decoding unit 230 may decode the coding unit of the current depth for the image data of the current maximum coding unit by using the partition type of the prediction unit, the prediction mode, and the transformation unit size information.

That is, by observing the encoding information set for the predetermined data unit among the coding unit, the prediction unit, and the minimum unit, the collection of data units retaining the encoding information including the same division information may be regarded as one data unit that is to be decoded in the same encoding mode by the image data decoding unit 230.

The video decoding apparatus 200 according to an exemplary embodiment may acquire the information about the coding unit generating the minimum encoding error by performing recursive encoding on each maximum coding unit in the encoding process and use the acquired information to decode the current picture. That is, the encoded image data of the coding units according to the tree structure determined as the optimum coding unit for each maximum coding unit may be decoded.

Thus, even in the case of an image having a high resolution or an image having an excessively large data amount, the image may be restored by efficiently decoding the image data according to the encoding mode and the size of the coding unit determined adaptively to the features of the image by using the information about the optimum encoding mode received from the encoding terminal.

Hereinafter, a method of determining the transformation unit, the prediction unit, and the coding units according to the tree structure according to an exemplary embodiment will be described in detail with reference to FIGS. 3 to 13.

FIG. 3 illustrates the concept of a hierarchical coding unit according to an exemplary embodiment.

By way of example, the sizes of the coding units may be represented by width×height and may include 64×64, 32×32, 16×16, and 8×8. The 64×64-sized coding unit may be divided into 64×64, 64×32, 32×64, and 32×32-sized partitions; the 32×32-sized coding unit may be divided into 32×32, 32×16, 16×32, and 16×16-sized partitions; the 16×16-sized coding unit may be divided into 16×16, 16×8, 8×16, and 8×8-sized partitions; and the 8×8-sized coding unit may be divided into 8×8, 8×4, 4×8, and 4×4-sized partitions.

For video data 310, the resolution is set to 1920×1080, the maximum size of the coding unit is set to 64, and the maximum depth is set to 2. For video data 320, the resolution is set to 1920×1080, the maximum size of the coding unit is set to 64, and the maximum depth is set to 3. For video data 330, the resolution is set to 352×288, the maximum size of the coding unit is set to 16, and the maximum depth is set to 1. The maximum depth illustrated in FIG. 3 represents the total frequency of division from the maximum coding unit to the minimum coding unit.

In the case of a high resolution or a large data amount, the maximum size of the encoding size may be relatively large in order to improve the encoding efficiency and also to accurately reflect the image features. Thus, for the video data 310 and 320 having the higher resolution than the video data 330, the maximum size of the encoding size may be selected as 64.

Since the maximum depth of the video data 310 is 2, coding units 315 of the video data 310 may include the maximum coding unit having a major-axis size of 64 and coding units having major-axis sizes of 32 and 16 generated by the two-layer higher depth and two-time division therefrom. On the other hand, since the maximum depth of the video data 330 is 1, coding units 335 of the video data 330 may include the coding units having a major-axis size of 16 and coding units having a major-axis size of 8 generated by the one-layer higher depth and one-time division therefrom.

Since the maximum depth of the video data 320 is 3, coding units 325 of the video data 320 may include the maximum coding unit having a major-axis size of 64 and coding units having major-axis sizes of 32, 16, and 8 generated by the three-layer higher depth and three-time division therefrom. The representation capability of the detailed information may be improved as the depth increases.

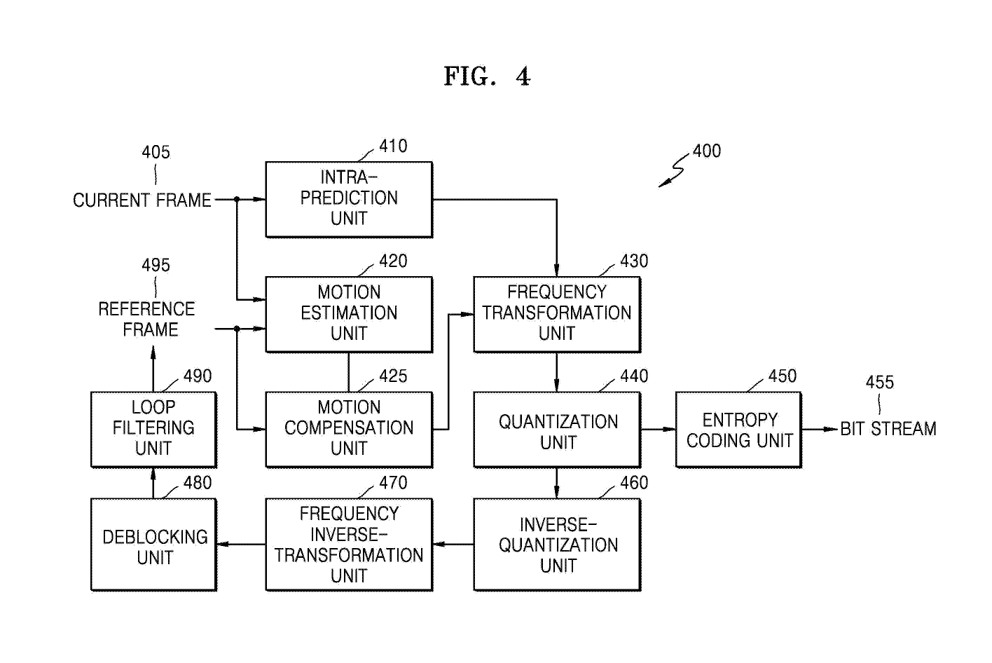

FIG. 4 is a block diagram of an image coding unit 400 (e.g., image coder or image encoder) based on a coding unit according to an exemplary embodiment.

An image coding unit 400 according to an exemplary embodiment includes operations through which the image data is encoded by the coding unit determining unit 120 of the video encoding apparatus 100. That is, an intra-prediction unit 410 (e.g., intra-predictor) performs intra-prediction on a coding unit of the intra mode in a current frame 405, and a motion estimation unit 420 (e.g., motion estimator) and a motion compensation unit 425 (e.g., motion compensator) perform inter-estimation and motion compensation by using a reference frame 495 and the current frame 405 of the inter mode.

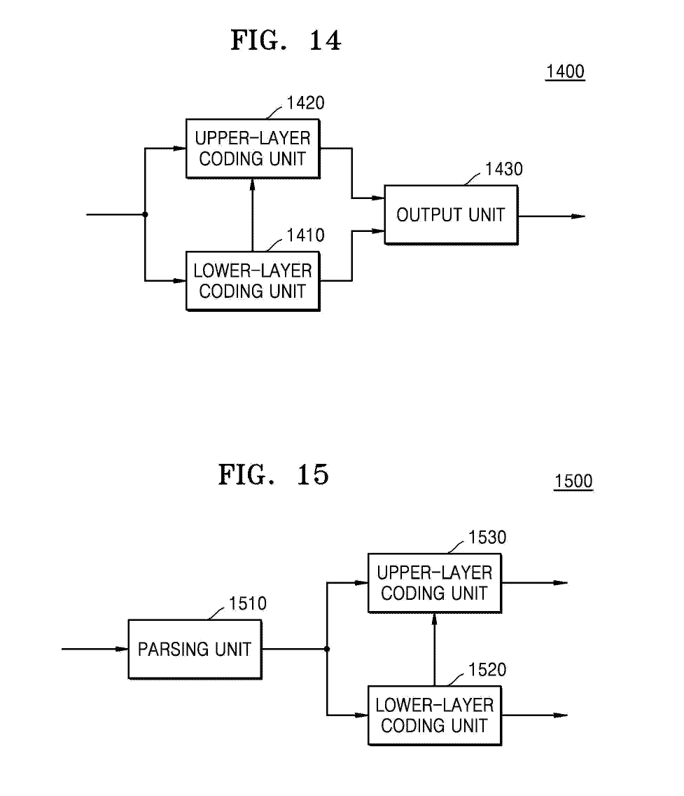

Data output from the intra-prediction unit 410, the motion estimation unit 420, and the motion compensation unit 425 is output as a quantized transformation coefficient through a frequency transformation unit 430 (e.g., frequency transformer) and a quantization unit 440 (e.g., quantizer). In particular, according to an exemplary embodiment, the motion estimation unit 420 and the motion compensation unit 425 perform pixel-unit bidirectional motion compensation in addition to block-based bidirectional motion prediction and compensation results in a bidirectional motion prediction and compensation process. This will be described in detail below with reference to FIG. 14.

The quantized transformation coefficient is restored as spatial-domain data through an inverse-quantization unit 460 (e.g., inverse-quantizer) and a frequency inverse-transformation unit 470 (e.g., frequency inverse-transformer), and the restored spatial-domain data is post-processed and output as the reference frame 495 through a deblocking unit 480 (e.g., deblocker) and a loop filtering unit 490 (e.g., loop filterer). The quantized transformation coefficient may be output as a bit stream 455 through an entropy coding unit 450 (e.g., entropy coder or entropy encoder).

For application to the video encoding apparatus 100 according to an exemplary embodiment, all of the intra-prediction unit 410, the motion estimation unit 420, the motion compensation unit 425, the frequency transformation unit 430, the quantization unit 440, the entropy coding unit 450, the inverse-quantization unit 460, the frequency inverse-transformation unit 470, the deblocking unit 480, and the loop filtering unit 490, which are the components of the image coding unit 400, may perform operations based on each coding unit among the coding units according to the tree structure in consideration of the maximum depth for each maximum coding unit.

In particular, the intra-prediction unit 410, the motion estimation unit 420, and the motion compensation unit 425 may determine the prediction mode and the partition of each coding unit among the coding units according to the tree structure in consideration of the maximum depth and the maximum size of the current maximum coding unit, and the frequency transformation unit 430 may determine the size of the transformation unit in each coding unit among the coding units according to the tree structure.

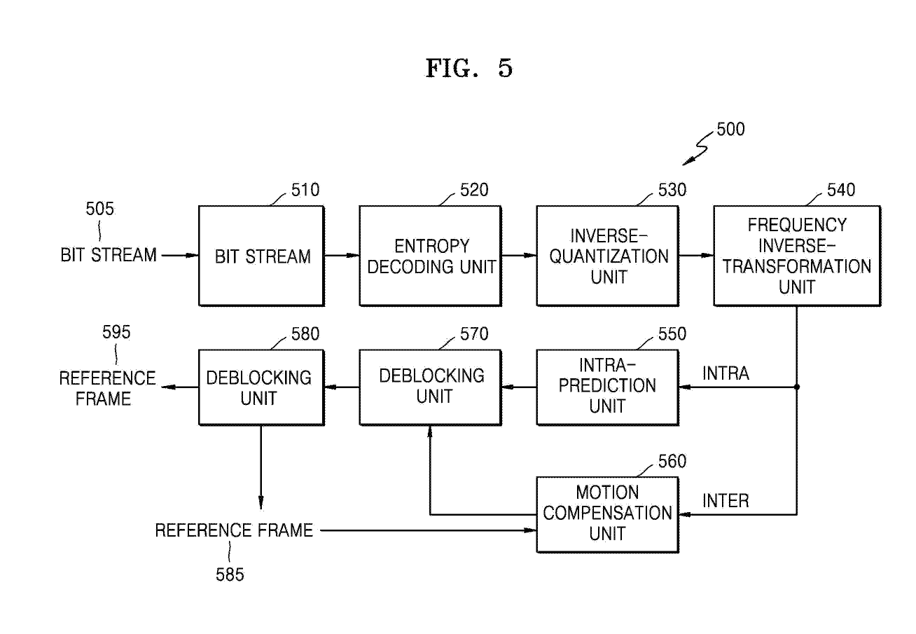

FIG. 5 is a block diagram of an image decoding unit 500 (e.g., image decoder) based on a coding unit according to an exemplary embodiment.

A bit stream 505 is parsed through a parsing unit 510 (e.g., parser) into encoded image data that is to be decoded and encoding-related information that is used for decoding. The encoded image data is output as inverse-quantized data through an entropy decoding unit 520 (e.g., entropy decoder) and an inverse-quantization unit 530 (e.g., inverse-quantizer), and spatial-domain image data is restored through a frequency inverse-transformation unit 540 (e.g., inverse-transformer).

For the spatial-domain image data, an intra-prediction unit 550 (e.g., intra-predictor) performs intra-prediction on the coding unit of the intra mode, and a motion compensation unit 560 (e.g., motion compensator) performs motion compensation on the coding unit of the inter mode by using a reference frame 585. In particular, the motion compensation unit 560 according to an exemplary embodiment performs pixel-unit bidirectional motion compensation in addition to block-based bidirectional motion compensation results in a bidirectional motion compensation process. This will be described in detail below with reference to FIG. 14.

The spatial-domain data output through the intra-prediction unit 550 and the motion compensation unit 560 may be post-processed and output as a restored frame 595 through a deblocking unit 570 (e.g., deblocker) and a loop filtering unit 580 (e.g., loop filterer). Also, the data post-processed through the deblocking unit 570 and the loop filtering unit 580 may be output as the reference frame 585.

Step-by-step operations following the parsing unit 510 of the image decoding unit 500 according to an exemplary embodiment may be performed in order to decode the image data by the image data decoding unit 230 of the video decoding apparatus 200.

For application to the video decoding apparatus 200 according to an exemplary embodiment, all of the parsing unit 510, the entropy decoding unit 520, the inverse-quantization unit 530, the frequency inverse-transformation unit 540, the intra-prediction unit 550, the motion compensation unit 560, the deblocking unit 570, and the loop filtering unit 580, which are the components of the image decoding unit 500, may perform operations based on the coding units according to the tree structure for each maximum coding unit.

In particular, the intra-prediction unit 550 and the motion compensation unit 560 may determine the prediction mode and the partition for each of the coding units according to the tree structure, and the frequency inverse-transformation unit 540 may determine the size of the transformation unit for each coding unit.

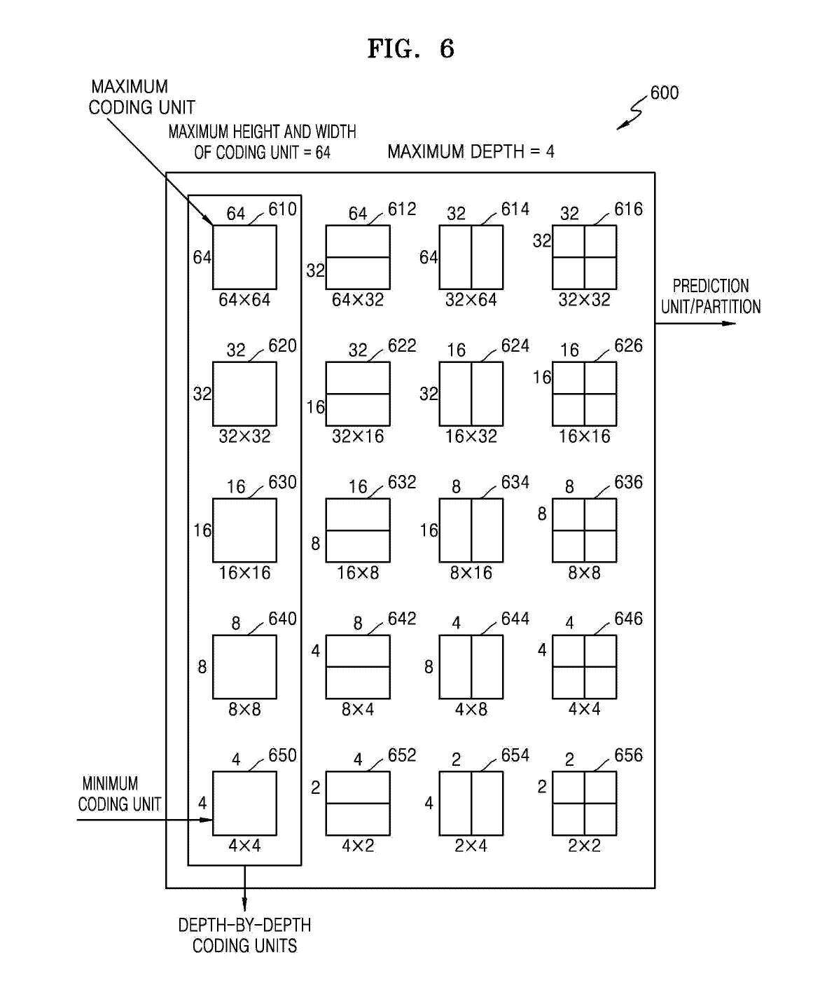

FIG. 6 illustrates depth-by-depth coding units and partitions according to an exemplary embodiment.

The video encoding apparatus 100 according to an exemplary embodiment and the video decoding apparatus 200 according to an exemplary embodiment use hierarchical coding units to consider the image features. The maximum depth and the maximum height and width of the coding unit may be determined adaptively according to the image features or may be set variously according to the user's requirements. The size of the depth-by-depth coding unit may be determined according to the preset maximum size of the coding unit.

A layer structure 600 of the coding units according to an exemplary embodiment illustrates the case where the maximum height and width of the coding unit are 64 and the maximum depth is 4. Since the depth increases along the vertical axis of the layer structure 600 of the coding units according to an exemplary embodiment, each of the height and width of the depth-by-depth coding unit is divided. Also, the prediction unit and the partition, on which prediction encoding of each depth-by-depth coding unit is based, are illustrated along the horizontal axis of the layer structure 600 of the coding units.

That is, a coding unit 610 is the maximum coding unit in the layer structure 600 of the coding units, in which the depth is 0 and the size (i.e., height and width) of the coding unit is 64×64. The depth increases along the vertical axis, in which a coding unit 620 has a size of 32×32 and a depth of 1; a coding unit 630 has a size of 16×16 and a depth of 2; a coding unit 640 has a size of 8×8 and a depth of 3; and a coding unit 650 has a size of 4×4 and a depth of 4. The coding unit 650 having a size of 4×4 and a depth of 4 is the minimum coding unit.

The partitions and the prediction unit of the coding unit are arranged along the horizontal axis for each depth. That is, when the coding unit 610 having a depth of 0 and a size of 64×64 is the prediction unit, the prediction unit may be divided into a 64×64-sized partition 610, 64×32-sized partitions 612, 32×64-sized partitions 614, and 32×32-sized partitions 616 that are included in the 64×64-sized coding unit 610.

Likewise, the prediction unit of the coding unit 620 having a depth of 1 and a size of 32×32 may be divided into a 32×32-sized partition 620, 32×16-sized partitions 622, 16×32-sized partitions 624, and 16×16-sized partitions 626 that are included in the 32×32-sized coding unit 620.

Likewise, the prediction unit of the coding unit 630 having a depth of 2 and a size of 16×16 may be divided into a 16×16-sized partition 630, 16×8-sized partitions 632, 8×16-sized partitions 634, and 8×8-sized partitions 636 that are included in the 16×16-sized coding unit 630.

Likewise, the prediction unit of the coding unit 640 having a depth of 3 and a size of 8×8 may be divided into an 8×8-sized partition 640, 8×4-sized partitions 642, 4×8-sized partitions 644, and 4×4-sized partitions 646 that are included in the 8×8-sized coding unit 640.

Lastly, the coding unit 650 having a depth of 4 and a size of 4×4 is the minimum coding unit and is the coding unit of the lowest depth, and the corresponding prediction unit may be set only as a 4×4-sized partition 650.

In order to determine the encoding depth of the maximum coding unit 610, the coding unit determining unit 120 of the video encoding apparatus 100 according to an exemplary embodiment should perform encoding on each coding unit of each depth included in the maximum coding unit 610.

As for the number of depth-by-depth coding units for including data of the same range and size, the number of depth-by-depth coding units also increases as the depth increases. For example, four coding units having a depth of 2 are necessary for the data included in one coding unit having a depth of 1. Thus, in order to compare the encoding results of the same data on a depth-by-depth basis, each encoding should be performed by using one coding unit having a depth of 1 and four coding units having a depth of 2.

For each depth-by-depth encoding, encoding may be performed on each of the prediction units of the depth-by-depth coding units along the horizontal axis of the layer structure 600 of the coding units, and the smallest encoding error in the corresponding depth may be selected as the representative encoding error. Also, the depth may increase along the vertical axis of the layer structure 600 of the coding units, and encoding may be performed on each depth and the depth-by-depth representative encoding errors may be compared to detect the minimum encoding error. The depth and the partition causing the minimum encoding error in the maximum coding unit 610 may be selected as the encoding depth and the partition type of the maximum coding unit 610.

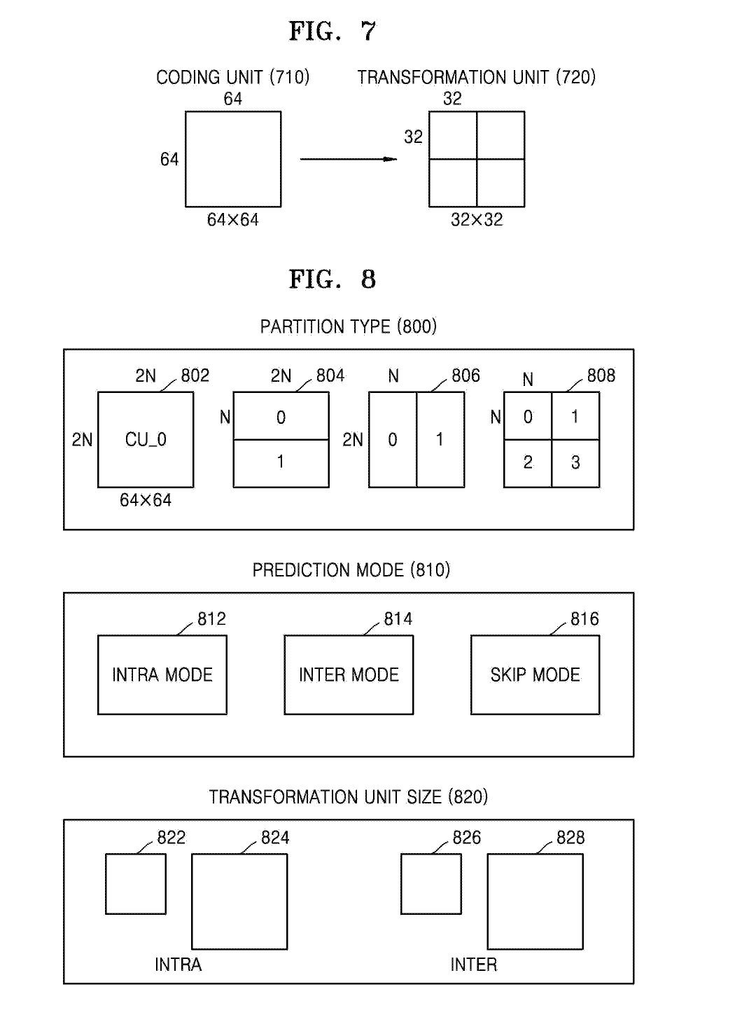

FIG. 7 illustrates the relationship between a coding unit 710 and a transformation unit 720 according to an exemplary embodiment.

The video encoding apparatus 100 according to an exemplary embodiment or the video decoding apparatus 200 according to an exemplary embodiment encodes or decodes the image for each maximum coding unit by the coding unit that is smaller than or equal is size to the maximum coding unit. In the encoding process, the size of the transformation unit for frequency transformation may be selected based on the data unit that is not larger than each coding unit.

For example, in the video encoding apparatus 100 according to an exemplary embodiment or the video decoding apparatus 200 according to an exemplary embodiment, when a current coding unit 710 has a size of 64×64, frequency transformation may be performed by using a 32×32-sized transform unit 720.

Also, after the data of the 64×64-sized coding unit 710 is encoded by transformation into each of the transformation units having sizes of 32×32, 16×16, 8×8, and 4×4 that are smaller than 64×64, the transformation unit having the smallest error with respect to the original may be selected.

FIG. 8 illustrates depth-by-depth encoding information according to an exemplary embodiment.

The output unit 130 of the video encoding apparatus 100 according to an exemplary embodiment may encode and transmit partition type information 800, prediction mode information 810, and transformation unit size information 820 as encoding mode information for each coding unit of each encoding depth.

The partition type information 800 represents information about the type of partitions generated by division of the prediction unit of the current coding unit, as the data unit for prediction encoding of the current coding unit. For example, a 2N×2N-sized current coding unit CU_0 may be divided and used as any one of a 2N×2N-sized partition 802, a 2N×N-sized partition 804, an N×2N-sized partition 806, and an NxN-sized partition 808. In this case, the partition type information 800 of the current coding unit may be set to represent one of the 2N×2N-sized partition 802, the 2N×N-sized partition 804, the N×2N-sized partition 806, and the NxN-sized partition 808.

The prediction mode information 810 represents the prediction mode of each partition. For example, the prediction mode information 810 may be use to set whether the partition indicated by the partition type information 800 is prediction-encoded in one of an intra mode 812, an inter mode 814, and a skip mode 816.

Also, the transformation unit size information 820 indicates whether to frequency-transform the current coding unit based on any transformation unit. For example, the transformation unit may be one of a first intra-transformation unit size 822, a second intra-transformation unit size 824, a first inter-transformation unit size 826, and a second inter-transformation unit size 828.

The image data and encoding information extracting unit 210 of the video decoding apparatus 200 according to an exemplary embodiment may extract the partition type information 800, the prediction mode information 810, and the transformation unit size information 820 for each depth-by-depth coding unit and use the extracted information to perform decoding.

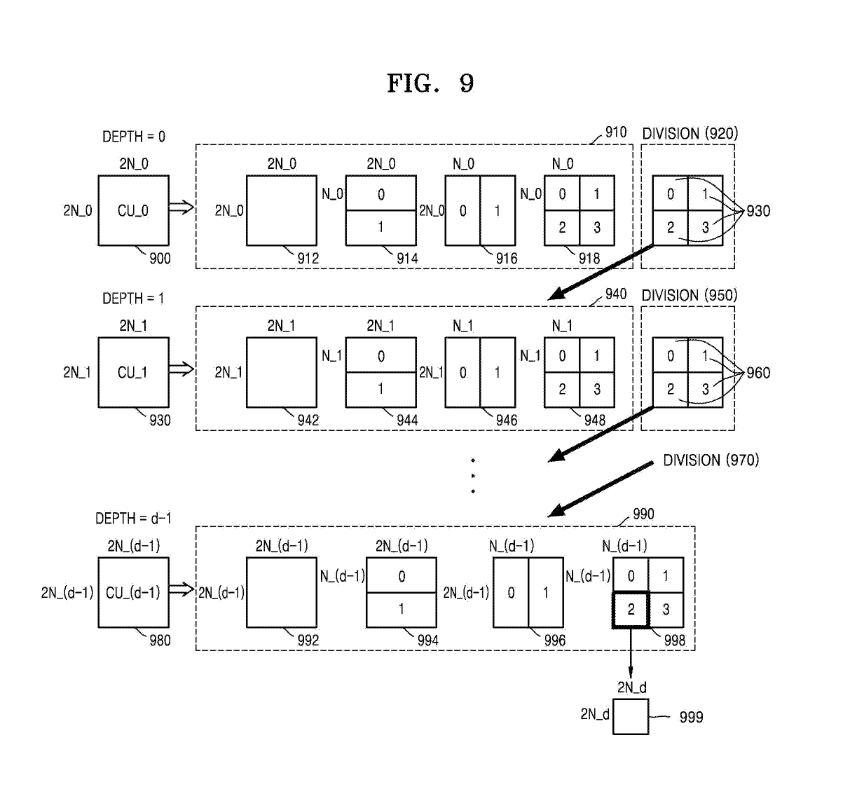

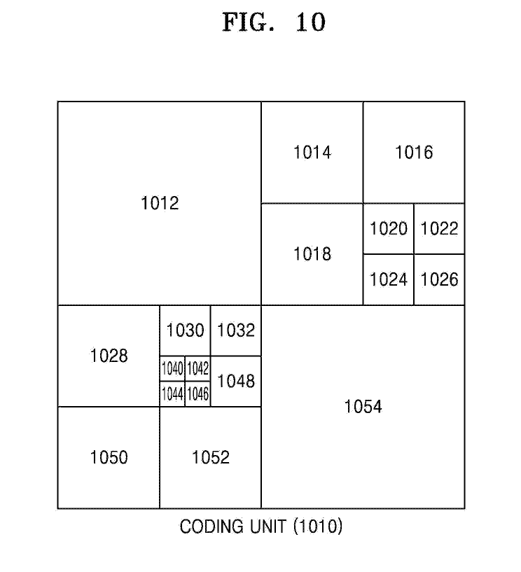

FIG. 9 illustrates depth-by-depth coding units according to an exemplary embodiment.

Division information (e.g., split information) may be used to indicate a depth change. The division information indicates whether the coding unit of the current depth is to be divided (e.g., split) into the coding units of the lower depth.

A prediction unit 910 for prediction encoding of a coding unit 900 having a depth of 0 and a size of 2N_{—}0×2N_{—}0 may include a 2N_{—}0×2N_{—}0-sized partition type 912, a 2N_{—}0×N_{—}0-sized partition type 914, an N_{—}0×2N_{—}0-sized partition type 916, and an N_{—}0×N_{—}0-sized partition type 918. Although only the partitions 912, 914, 916, and 918 generated by division of the prediction unit in a symmetrical ratio are illustrated, the partition types are not limited thereto and may include asymmetrical partitions, random-type partitions, and geometrical-type partitions as described above.

For each partition type, prediction encoding should be repeatedly performed on each of one 2N_{—}0×2N_{—}0-sized partition, two 2N_{—}0×N_{—}0-sized partitions, two N_{—}0×2N_{—}0-sized partitions, and four N_{—}0×N_{—}0-sized partitions. Prediction encoding may be performed in the intra mode and the inter mode on the 2N_{—}0×2N_{—}0-sized, N_{—}0×2N_{—}0-sized, 2N_{—}0×N_{—}0-sized, and N_{—}0×N_{—}0-sized partitions. In the skip mode, prediction encoding may be performed only on the 2N_{—}0×2N_{—}0-sized partition.

When the encoding error caused by one of the 2N_{—}0×2N_{—}0-sized, 2N_{—}0×N_{—}0-sized, and N_{—}0×2N_{—}0-sized partition types 912, 914, and 916 is smallest, there is no need for division into the lower depth any more.

When the encoding error caused by the N_{—}0×N_{—}0-sized partition type 918 is smallest, the depth may be changed from 0 into 1, division may be performed (920), and encoding may be repeatedly performed on coding units 930 of the partition type having a depth of 2 and a size of N_{—}0×N_{—}0 to detect the minimum encoding error.

A prediction unit 940 for prediction encoding of the coding unit 930 having a depth of 1 and a size of 2N_{—}1×2N_{—}1 (=N_{—}0×N_{—}0) may include a 2N_{—}1×2N_{—}1-sized partition type 942, a 2N_{—}1×N_{—}1-sized partition type 944, an N_{—}1×2N_{—}1-sized partition type 946, and an N_{—}1×N_{—}1-sized partition type 948.

Also, when the encoding error caused by the N_{—}1×N_{—}1-sized partition type 948 is smallest, the depth may be changed from 1 into 2, division may be performed (950), and encoding may be repeatedly performed on coding units 960 having a depth of 2 and a size of N_{—}2×N_{—}2 to detect the minimum encoding error.

When the maximum depth is d, the depth-by-depth division information may be set up to the depth d-1 and the division information may be set up to the depth d-2. That is, when division is performed from the depth d-2 (970) to perform encoding up to the depth d-1, a prediction unit 990 for prediction encoding of a coding unit 980 having a depth of d-1 and a size of 2N_(d-1)×2N_(d-1) may include a 2N_(d-1)×2N_(d-1)-sized partition type 992, a 2N_(d-1)×N_(d-1)-sized partition type 994, an N_(d-1)×2N_(d-1)-sized partition type 996, and an N_(d-1)×N_(d-1)-sized partition type 998.

Prediction encoding may be repeatedly performed on each of one 2N_(d-1)×2N_(d-1)-sized partition, two 2N_(d-1)×N_(d-1)-sized partitions, two N_(d-1)×2N_(d-1)-sized partitions, and four N_(d-1)×N_(d-1)-sized partitions to detect the partition type causing the minimum encoding error among the partition types.

Even when the encoding error caused by the N_(d-1)×N_(d-1)-sized partition type 998 is smallest, since the maximum depth is d, a coding unit CU_(d-1) of the depth d-1 may not be divided into the lower depth any more, the encoding depth of the current maximum coding unit 900 is determined as the depth d-1, and the partition type may be determined as N_(d-1)×N_(d-1). Also, since the maximum depth is d, division information is not set for a coding unit 952 of the depth d-1.

A data unit 999 may be referred to as ‘minimum unit’ for the current maximum coding unit. The minimum unit according to an exemplary embodiment may be a square data unit having a size generated by quad-division of the minimum coding unit that is the lowest encoding depth. Through this repeated encoding process, the video encoding apparatus 100 according to an exemplary embodiment may compare the depth-by-depth encoding errors of the coding unit 900, select the depth causing the smallest encoding error, determine the encoding depth, and set the corresponding partition type and the prediction mode as the encoding mode of the encoding depth.

In this way, by comparing all the depth-by-depth minimum encoding errors of the depths 0, 1, . . . , d-1, d, the depth having the smallest error may be selected and determined as the encoding depth. The encoding depth, the prediction mode, and the partition type of the prediction unit may be encoded and transmitted as the encoding mode information. Also, since the coding unit should be divided from the depth 0 to the encoding depth, only the division information of the encoding depth may be set to ‘0’ and the depth-by-depth division information except the encoding depth should be set to ‘1’.

The image data and encoding information extracting unit 220 of the video decoding apparatus 200 according to an exemplary embodiment may extract information about the prediction unit and the encoding depth for the coding unit 900 and use the extracted information to decode the coding unit 912. The video decoding apparatus 200 according to an exemplary embodiment may use the depth-by-depth division information to determine the depth of the division information ‘0’ as the encoding depth and use the information about the encoding mode of the corresponding depth to perform decoding.

FIGS. 10, 11, and 12 illustrate the relationship between a coding unit 1010, a prediction unit 1060, and a transformation unit 1070 (e.g., frequency transformation unit) according to an exemplary embodiment.

Coding units 1010 include the depth-by-depth coding units that are determined for the maximum coding unit by the video encoding apparatus 100 according to an exemplary embodiment. Prediction units 1060 include the partitions of the prediction units of each depth-by-depth coding unit in the coding unit 1010, and transformation units 1070 include the transformation units of each depth-by-depth coding unit.

As for the depth-by-depth coding units 1010, when the depth of the maximum coding unit is 0, the depth of coding units 1012 and 1054 is 1, the depth of coding units 1014, 1016, 1018, 1028, 1050, and 1052 is 2, the depth of coding units 1020, 1022, 1024, 1026, 1030, 1032, and 1048 is 3, and the depth of coding units 1040, 1042, 1044, and 1046 is 4.

Among the prediction units 1060, some partitions 1014, 1016, 1022, 1032, 1048, 1050, 1052, and 1054 are divided types of the coding unit. That is, the partitions 1014, 1022, 1050, and 1054 are of a 2N×N-sized partition type, the partitions 1016, 1048, and 1052 are of an N×2N-sized partition type, and the partition 1032 is of an N×N-sized partition type. The partitions and the prediction units of the depth-by-depth coding units 1010 are smaller than or equal in size to each coding unit.

Frequency transformation or frequency inverse-transformation is performed on the image data of some (1052) of the transformation unit 1070 by the data unit that is smaller in size than the coding unit. Also, when compared with the partition and the corresponding prediction unit among the prediction units 1060, the transformation units 1014, 1016, 1022, 1032, 1048, 1050, 1052, and 1054 are data units of different sizes or types. That is, the video encoding apparatus 100 according to an exemplary embodiment and the video decoding apparatus 200 according to an exemplary embodiment may perform an intra-prediction/motion estimation/motion compensation operation and a frequency transformation/inverse-transformation operation on the same coding unit based on different data units.

Accordingly, encoding may be recursively performed on each of the coding units of the hierarchical structure for each region for the maximum coding unit and the optimum coding unit may be determined, so that the coding units according to a recursive tree structure may be generated. The encoding information may include coding unit division information, partition type information, prediction mode information, and transformation unit size information. Table 1 below shows an example that may be set by the video encoding apparatus 100 according to an exemplary embodiment and the video decoding apparatus 200 according to an exemplary embodiment.

TABLE 1

| Division Information 0 (Encoding for Coding unit Having a Current Depth | | | | | |
|---|---|---|---|---|---|
| of d and a Size of 2N × 2N) | | | | | |
| | | | Transformation Unit Size | | |
| | Partition Type | | | Transformation | |
| | Symmetric | Asymmetric | Transformation | Unit | |
| Prediction | Partition | Partition | Unit Division | Division | Division |
| Mode | Type | Type | Information 0 | Information 1 | Information 1 |
| Intra Inter | 2N × 2N2N × | 2N × nU2N × | 2N × 2N | N × N | Repeated |
| Skip | NN × 2NN × N | nDnL × 2NnR × | | (Symmetric | Encoding |
| (2N × 2N | | 2N | | Partition Type) | for Each |
| only) | | | | N/2 × N/2 | of Coding |
| | | | | (Asymmetric | units |
| | | | | Partition Type) | having a |
| | | | | | Lower |
| | | | | | Depth of |
| | | | | | (d + 1) |

The output unit 130 of the video encoding apparatus 100 according to an exemplary embodiment may output the encoding information about the coding units according to the tree structure, and the image data and encoding information extracting unit 220 of the video decoding apparatus 200 according to an exemplary embodiment may extract the encoding information about the coding units according to the tree structure from the received bit stream.

The division information indicates whether the current coding unit is divided into the coding units of the lower depth. When the division information of the current depth d is 0, since the encoding depth is the depth in which the current coding unit is not divided into the lower coding units any more, the partition type information, the prediction mode, and the transformation unit size information may be defined for the encoding depth. When one-step more division should be performed according to the division information, encoding should be independently performed on each of the divided four lower-depth coding units.

The prediction mode may be represented by one of the intra mode, the inter mode, and the skip mode. The intra mode and the inter mode may be defined in all partition types, and the skip mode may be defined only in the partition type 2N×2N.

The partition type information may represent symmetric partition types 2N×2N, 2N×N, N×2N, and NxN in which the height or width of the prediction unit is divided in a symmetrical ratio and asymmetric partition types 2N×nU, 2N×nD, nL×2N, and nR×2N in which the height or width of the prediction unit is divided in an asymmetrical ratio. The asymmetric partition types 2N×nU and 2N×nD respectively represent the types in which the height is divided in 1:3 and 3:1, and the asymmetric partition types nL×2N and nR×2N respectively represent the types in which the width is divided in 1:3 and 3:1.

The transformation unit sizes may be set as two types of sizes in the intra mode and may be set as two types of sizes in the inter mode. That is, when the transformation unit division information is 0, the transformation unit size is set as the size 2N×2N of the current coding unit. When the transformation unit division information is 1, the transformation unit of a size generated by division of the current coding unit may be set. Also, when the partition type of the 2N×2N-sized current coding unit is a symmetric partition type, the transformation unit size may be set as N×N; and when the partition type of the 2N×2N-sized current coding unit is an asymmetric partition type, the transformation unit size may be set as N/2×N/2.

The encoding information of the coding units according to the tree structure according to an exemplary embodiment may be set for at least one of the minimum unit, the prediction unit, and the coding unit of the encoding depth. The coding unit of the encoding depth may include one or more minimum units and prediction units that retain the encoding information.

Thus, when the encoding information retained by each of the adjacent data units is detected, it may be detected whether they are included in the coding unit of the same encoding depth. Also, since the coding unit of the corresponding encoding depth may be detected by using the encoding information retained by the data unit, the distribution of the encoding depths in the maximum coding unit may be inferred.

Thus, when the current coding unit is predicted with reference to the adjacent data unit, the encoding information of the data unit in the depth-by-depth coding units adjacent to the current coding unit may be used directly by reference.

Also, according to another exemplary embodiment, when the current coding unit is prediction-encoded with reference to the adjacent coding unit, the encoding information of the adjacent depth-by-depth coding units may be used to detect the data adjacent to the current coding unit in the depth-by-depth coding units to refer to the adjacent coding unit.

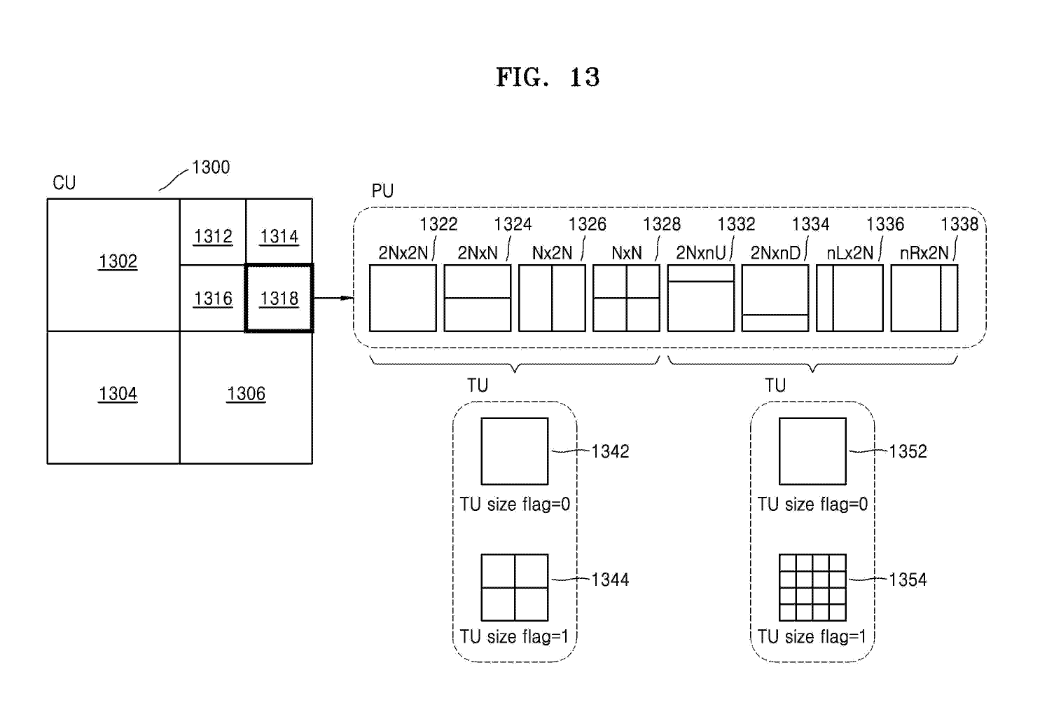

FIG. 13 illustrates the relationship between a coding unit, a prediction unit, and a transformation unit according to encoding mode information of Table 1.

A maximum coding unit 1300 includes coding units 1302, 1304, 1306, 1312, 1314, 1316, and 1318 of the encoding depth. Since the coding unit 1318 is the coding unit of the encoding depth, the division information may be set to 0. The partition type information of the 2N×2N-sized coding unit 1318 may be set as one of partition types 2N×2N (1322), 2N×N (1324), N×2N (1326), N×N (1328), 2N×nU (1332), 2N×nD (1334), nL×2N (1336), and nR×2N (1338).

In the case where the partition type information is set as one of symmetric partition types 2N×2N (1322), 2N×N (1324), N×2N (1326), and N×N (1328), when transformation unit division information (TU size flag) is 0, a 2N×2N-sized transformation unit 1342 may be set; and when the transformation unit division information is 1, an NxN-sized transformation unit 1344 may be set.

In the case where the partition type information is set as one of asymmetric partition types 2N×nU (1332), 2N×nD (1334), nL×2N (1336), and nR×2N (1338), when transformation unit division information (TU size flag) is 0, a 2N×2N-sized transformation unit 1352 may be set; and when the transformation unit division information is 1, an N/2×N/2-sized transformation unit 1354 may be set.

Hereinafter, a motion compensation process performed by the motion compensation unit 425 of the video encoding apparatus 100 of FIG. 4 according to an exemplary embodiment and the motion compensation unit 560 of the video decoding apparatus 200 of FIG. 5 according to an exemplary embodiment will be described in detail. Also, a method of performing motion compensation in scalable video of a plurality of layers by expanding a motion compensation process for video of one layer will be described. In the following description, the above-described prediction unit will be referred to as ‘block’.

FIG. 14 is a block diagram of a scalable video encoding apparatus 1400 according to an exemplary embodiment.

The scalable video encoding apparatus 1400 classifies an input image into a base layer video sequence and an enhancement layer video sequence and encodes the base layer video sequence and the enhancement layer video sequence to generate and output a scalable bit stream. In order to provide optimum services in various network environments and various terminals, the scalable video encoding apparatus 1400 outputs a scalable bit stream including various spatial resolutions, various qualities, and various frame rates. Each terminal may receive and restore a bit stream of a predetermined layer according to its capability. In the following description, the base layer video may be referred to as ‘lower-layer video’ and the enhancement layer video may be referred to as ‘upper-layer video’.

Referring to FIG. 14, the scalable video encoding apparatus 1400 according to an exemplary embodiment includes a lower-layer coding unit 1410 (e.g., lower-layer coder), an upper-layer coding unit 1420 (e.g., upper-layer coder), and an output unit 1430 (e.g., outputter or output device).

The lower-layer coding unit 1410 encodes a lower-layer image. The lower-layer coding unit 1410 may encode the lower-layer image based on the coding units of the tree structure described with reference to FIGS. 1 to 13. That is, the lower-layer coding unit 1410 may divide the lower-layer image into the maximum coding units and determine the encoding modes of the coding units generated by hierarchical division of each maximum coding unit, to encode the lower-layer image. Also, the lower-layer coding unit 1410 determines and outputs the optimum prediction unit and the transformation unit for each coding unit.

In particular, the lower-layer coding unit 1410 may acquire an accurate motion compensation value by using a weighted sum of a block-based motion compensation value and a pixel-unit motion compensation value acquired in a motion compensation process. As described below, the lower-layer coding unit 1410 may acquire a displacement motion vector of each pixel of the current block by using two reference pictures of the lower-layer encoded current block and generate a pixel-unit motion compensation value by using the acquired displacement motion vector and the gradient value of the corresponding pixel acquired from the two reference pictures.

The upper-layer coding unit 1420 encodes an upper-layer image. The upper-layer coding unit 1420 may encode the upper-layer image based on the coding units of the tree structure. Also, the upper-layer coding unit 1420 may prediction-encode the upper-layer image with reference to the encoding information of the lower-layer image restored after being encoded by the lower-layer coding unit 1410. The upper-layer coding unit 1420 may encode the upper-layer image with reference to the structure information of the coding unit of the lower-layer image, the structure information of the prediction unit included in the coding unit of the lower-layer image, the structure information of the transformation unit, and the motion information as the encoding information.

In particular, as described below, the upper-layer coding unit 1420 may acquire a motion compensation prediction value of the current block of the upper layer by using a weighted sum of the prediction value of the corresponding block of the lower layer corresponding to the current block of the upper layer and the motion compensation prediction value of the current block of the upper layer. The motion compensation prediction value of the current block of the upper layer is acquired by using a weighted sum of the pixel-unit motion compensation prediction value and the block-unit prediction value according to the block-unit motion compensation result of the current block. The pixel-unit motion compensation prediction value may be acquired by using the displacement motion vector of each pixel, which is acquired by using two reference pictures of the current block of the bidirectionally-predicted upper layer and the corresponding block of the lower layer corresponding to the current block, and the gradient value acquired from the two reference pictures.

A mode for prediction-encoding the upper-layer image with reference to the encoding information of the lower-layer image is defined as an inter-layer prediction mode. Also, the upper-layer coding unit 1420 may prediction-encode the upper-layer image independently without reference to the encoding information of the lower-layer image.

The upper-layer coding unit 1420 according to an exemplary embodiment may divide the maximum coding unit of the upper-layer image into the coding units of the tree structure based on the division structure of the maximum coding unit of the lower-layer image. Also, the upper-layer coding unit 1420 may divide the data unit of the upper-layer image, which is acquired based on the division structure of the lower-layer image, into the smaller data units. The data unit represents one of the maximum coding unit, the coding unit, the prediction unit, and the transformation unit. For example, the upper-layer coding unit 1420 may determine the structure of the prediction unit included in the coding unit of the upper-layer image, based on the structure information of the prediction unit included in the coding unit of the lower-layer image. Then, the upper-layer coding unit 1420 may determine whether to perform additional division of the data unit of the upper-layer image, by comparing a first cost according to the result of prediction-encoding of the upper-layer image by use of the data unit included in the initial division structure of the upper-layer image acquired based on the division structure of the lower-layer image and a second cost according to the result of prediction-encoding of the upper-layer image by additional division of the data unit included in the initial division structure of the upper-layer image.

The output unit 1430 outputs the encoding information related to the lower-layer image according to the encoding result of the lower-layer coding unit 1410. Also, the output unit 1430 may output the encoding information related to the upper-layer image according to the encoding result of the upper-layer coding unit 1420. The encoding information may include various types of encoding-related information such as structure information of the maximum coding unit constituting the upper-layer image and the lower-layer image, structure information of the prediction unit, structure information of the transformation unit, and prediction mode information of the prediction unit. In particular, when accurate motion compensation is performed through pixel-based motion compensation in addition to block-based motion compensation according to exemplary embodiments, the output unit 1430 may output flag information indicating whether the accurate motion compensation according to one or more exemplary embodiments is performed, as the encoding information. Based on the flag information, the decoding side may determine whether to acquire the prediction value of the block through general block-based motion compensation with respect to the block encoded through bidirectional motion prediction and compensation, or whether to acquire the prediction value through accurate motion compensation based on pixel-based motion compensation in addition to block-based motion compensation as described below.

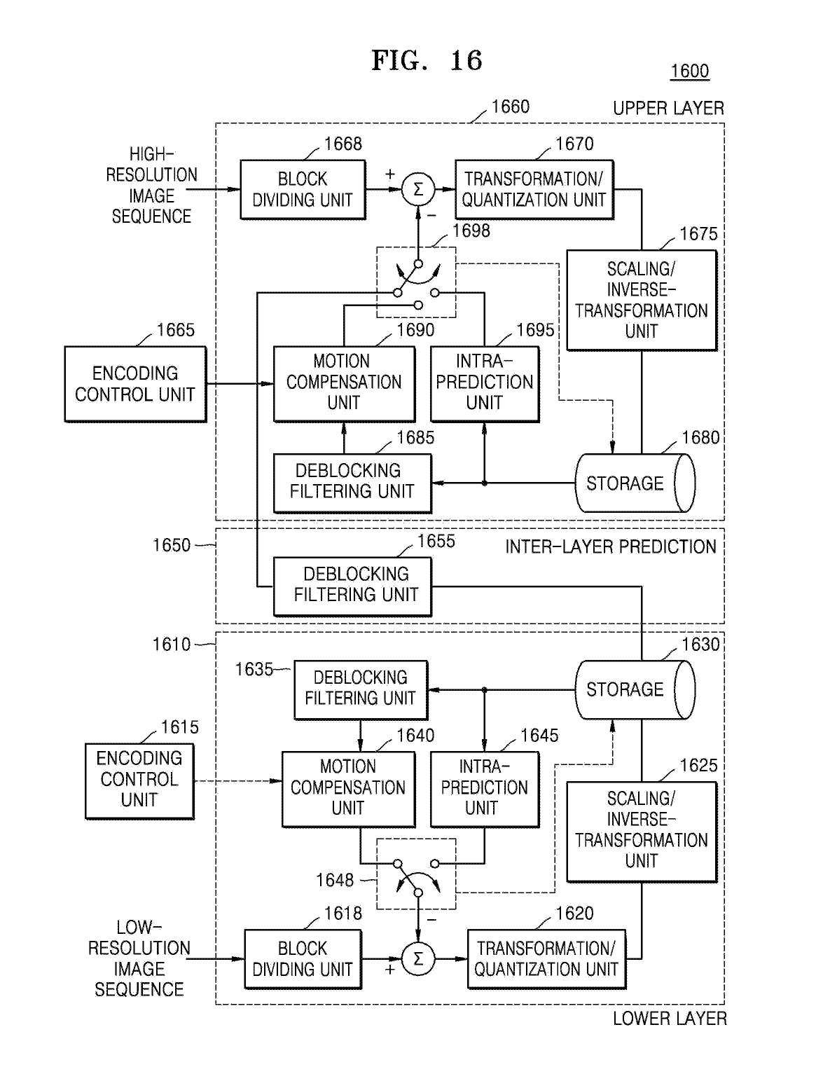

FIG. 15 is a block diagram of a scalable video decoding apparatus 1500 according to an exemplary embodiment.

A scalable video decoding apparatus 1500 according to an exemplary embodiment includes a parsing unit 1510 (e.g., parser), a lower-layer decoding unit 1520 (e.g., lower-layer decoder), and an upper-layer decoding unit 1530 (e.g., upper-layer decoder).

The parsing unit 1510 parses the encoding information of the lower-layer image and the encoding information of the upper-layer image from the received bit stream.

The lower-layer decoding unit 1520 decodes the lower-layer image based on the parsed encoding information of the lower-layer image. The lower-layer decoding unit 1520 may determine the coding unit of the tree structure generated by division of the maximum coding unit for each maximum coding unit of the lower-layer image and generate the prediction value of each coding unit according to the prediction mode of each coding unit to perform decoding on each maximum coding unit. The lower-layer decoding unit 1520 may acquire the prediction value of the current block by using a weighted sum of the block-based motion compensation prediction value and the pixel-unit motion compensation prediction value, with respect to the bidirectionally-predicted current block.

The upper-layer decoding unit 1530 decodes the upper-layer image based on the encoding information of the upper-layer image. The upper-layer decoding unit 1530 may decode the upper-layer image based on the coding units of the tree structure. The upper-layer decoding unit 1420 may determine the division structure of the maximum coding unit included in the lower-layer image, the division structure of the prediction unit, the division structure of the transformation unit by using the division structure of the maximum coding unit of the upper-layer image, the structure of the prediction unit included in the coding unit, and the structure of the transformation unit, and determine the division structure of the maximum coding unit included in the upper-layer image, the division structure of the prediction unit, the division structure of the transformation unit by using the division structure of the maximum coding unit of the upper-layer image, the structure of the prediction unit included in the coding unit, and the structure of the transformation unit.

When the structure of the coding unit included in the maximum coding unit of the upper-layer image, the structure of the prediction unit, and the structure of the transformation unit are determined, the upper-layer decoding unit 1530 may acquire the encoding information necessary for decoding the upper-layer image with reference to the encoding information of the lower-layer image and decode the upper-layer image by using the acquired encoding information. For example, the upper-layer decoding unit 1530 may acquire the motion information and the prediction mode information to be applied to the prediction unit of the upper layer based on the motion information and the prediction mode information of the prediction unit of the lower layer corresponding to the prediction unit of the currently-decoded upper layer and decode the prediction unit of the upper layer based on the acquired prediction mode information and motion information.

The upper-layer decoding unit 1530 may correct the encoding information inferred from the lower-layer image and determine the encoding information of the upper-layer image by using the corrected encoding information. The upper-layer decoding unit 1530 may use the encoding information of the upper-layer image determined based on the encoding information of the lower-layer image to decode the upper-layer image, or may change the encoding information of the upper-layer image determined from the encoding information of the lower-layer image based on the change information acquired from the bit stream and use the changed encoding information to decode the upper-layer image. For example, the upper-layer decoding unit 1530 may acquire the initial motion vector of the current block of the upper layer based on the motion vector of the corresponding block of the lower layer and correct the initial motion vector based on the correction motion vector information included in the bit stream, to acquire the final motion vector to be applied to the current block of the upper layer.

In particular, the upper-layer decoding unit 1530 may acquire a motion compensation prediction value of the current block of the upper layer by using a weighted sum of the prediction value of the corresponding block of the lower layer corresponding to the current block of the upper layer and the motion compensation prediction value of the current block of the upper layer. The motion compensation prediction value of the current block of the upper layer is acquired by using a weighted sum of the pixel-unit motion compensation prediction value and the block-unit prediction value according to the block-unit motion compensation result of the current block. The pixel-unit motion compensation prediction value may be acquired by using the displacement motion vector of each pixel, which is acquired by using two reference pictures of the current block of the bidirectionally-predicted upper layer and the corresponding block of the lower layer corresponding to the current block, and the gradient value acquired from the two reference pictures.

FIG. 16 is a block diagram of a scalable encoding apparatus 1600 according to an exemplary embodiment.

The scalable encoding apparatus 1600 includes a lower-layer encoding apparatus 1610 (e.g., lower-layer encoder), an upper-layer encoding apparatus 1660 (e.g., upper-layer encoder), and an inter-layer prediction apparatus 1650 (e.g., inter-layer predictor). The lower-layer encoding apparatus 1610 and the upper-layer encoding apparatus 1660 may correspond respectively to the lower-layer coding unit 1410 and the upper-layer coding unit 1420 of FIG. 14.

A block dividing unit 1618 (e.g., block divider) of the lower layer divides the lower-layer image by the data units such as the maximum coding units, the coding units, the prediction units, and the transformation units. Intra-prediction or inter-prediction may be performed on the prediction unit included in the coding unit output from the block dividing unit 1618. A motion compensation unit 1640 (e.g., motion compensator) outputs the prediction value of the prediction unit by performing inter-prediction on the prediction unit, and an intra-prediction unit 1645 (e.g., intra-predictor) outputs the prediction value of the prediction unit by performing intra-prediction on the prediction unit.

In particular, the motion compensation unit 1640 may acquire an accurate motion compensation prediction value by using a weighted sum of a block-based motion compensation prediction value and a pixel-unit motion compensation value acquired in a motion compensation process. The motion compensation unit 1640 may determine the corresponding region of two reference pictures of the lower-layer block through bidirectional prediction and acquire the block-based motion compensation prediction value of the lower-layer block by using the average value of the corresponding region. Also, as described below, the motion compensation unit 1640 may acquire a displacement motion vector of each pixel by using two reference pictures of the encoded current block of the lower layer and generate a pixel-unit motion compensation value by using the acquired displacement motion vector and the gradient value acquired from the two reference pictures.

An encoding control unit 1615 (e.g., encoding controller) determines the prediction mode used to acquire the prediction value, which is most similar to the current prediction unit, among the intra-prediction mode and the inter-prediction mode and controls a prediction switch 1648 to output the prediction value according to the determined prediction mode. A residual, which is a difference value between the current block and the prediction value of the current block acquired through intra-prediction or inter-prediction, is transformed and quantized by a transformation/quantization unit 1620 (e.g., transformer/quantizer), so that a quantized transformation coefficient is output. A scaling/inverse-transformation unit 1625 (e.g., scaler/inverse-transformer) restores the residual by performing scaling and inverse-transformation on the quantized transformation coefficient. A storage 1630 stores the current block that is restored by adding the restored residual and the prediction value of the current block. An encoding process is repeatedly performed on each of all the coding units of the lower-layer image divided by the block dividing unit 1618. The structure of the transformation unit, the prediction unit, the coding unit, and the maximum coding unit of the lower-layer image having the minimum cost may be determined according to the encoding process of the lower-layer image. A deblocking filtering unit 1635 performs filtering on the restored lower-layer image to reduce the artifact included in the restored lower-layer image.

The inter-layer prediction apparatus 1650 outputs the lower-layer image information to the upper-layer encoding apparatus 1660 so that the lower-layer image may be used for prediction encoding of the upper-layer image. A deblocking unit 1655 (e.g., deblocker) of the inter-layer prediction apparatus 1650 performs deblocking filtering on the restored lower-layer image and output the filtered lower-layer image to the upper-layer encoding apparatus 1660.

The upper-layer encoding apparatus 1660 encodes the upper-layer image based on the encoding information of the lower-layer image encoded by the lower-layer encoding apparatus 1610. The upper-layer encoding apparatus 1660 may use the encoding information of the lower-layer image determined by the lower-layer encoding apparatus 1610 or may change the encoding information of the lower-layer image to determine the encoding information to be used for encoding of the upper-layer image.

A block dividing unit 1668 (e.g., block divider) of the upper layer divides the upper-layer image by the data units such as the maximum coding units, the coding units, the prediction units, and the transformation units. The block dividing unit 1668 of the upper layer may determine the structure of the data unit of the corresponding upper-layer image based on the structure information of the data unit such as the transformation unit, the prediction unit, the coding unit, and the maximum coding unit determined in the lower-layer image.

Intra-prediction or inter-prediction may be performed on each prediction unit included in the upper-layer coding unit output from the block dividing unit 1668. A motion compensation unit 1690 (e.g., motion compensator) outputs the prediction value by performing inter-prediction on current block, and an intra-prediction unit 1695 (e.g., intra-predictor) outputs the prediction value by performing intra-prediction on the current block. The motion compensation unit 1690 may determine the motion vector of the upper-layer block by scaling the motion vector of the lower-layer block corresponding to the upper-layer block. For example, when the lower-layer image has a resolution of a*b (where a and b are integers), the corresponding upper-layer image has a resolution of 2a*2b, and the motion vector of the corresponding block of the lower layer is mv_base, 2*mv_base obtained by two-time upscaling the motion vector of the lower-layer block according to the resolution ratio between the lower-layer image and the upper-layer image may be determined as the motion vector of the upper-layer block. Also, the motion compensation unit 1690 may determine the motion vector of the upper-layer current block by performing independent motion prediction without using the motion vector of the lower layer.

In particular, the motion compensation unit 1690 of the upper layer may acquire a motion compensation prediction value of the upper-layer current block by using a weighted sum of a prediction value of the corresponding block of the lower layer corresponding to the current block of the upper layer and a motion compensation prediction value of the current block of the upper layer. The motion compensation prediction value of the current block of the upper layer may be acquired by using a weighted sum of a pixel-unit motion compensation prediction value and a block-unit prediction value according to the block-unit motion compensation result of the current block. The pixel-unit motion compensation prediction value may be acquired by using the displacement motion vector of each pixel, which is acquired by using two reference pictures of the current block of the bidirectionally-predicted upper layer and the corresponding block of the lower layer corresponding to the current block, and the gradient value acquired from the two reference pictures.

An encoding control unit 1665 (e.g., encoding controller) of the upper layer determines the prediction mode having the most similar prediction value to the current block of the upper layer among the intra-prediction mode and the inter-prediction mode and controls a prediction switch 1698 to output the prediction value of the current block according to the determined prediction mode. A residual, which is a difference value between the current block and the prediction value acquired through intra-prediction or inter-prediction, is transformed and quantized by a transformation/quantization unit 1670 (e.g., transformer/quantizer), so that a quantized transformation coefficient is output. A scaling/inverse-transformation unit 1675 (e.g., scaler/inverse-transformer) restores the residual by performing scaling and inverse-transformation on the quantized transformation coefficient. A storage 1680 stores the current prediction unit that is restored by adding the restored residual and the prediction value of the current block. A deblocking unit 1685 (e.g., deblocker) performs deblocking filtering on the restored upper-layer image.

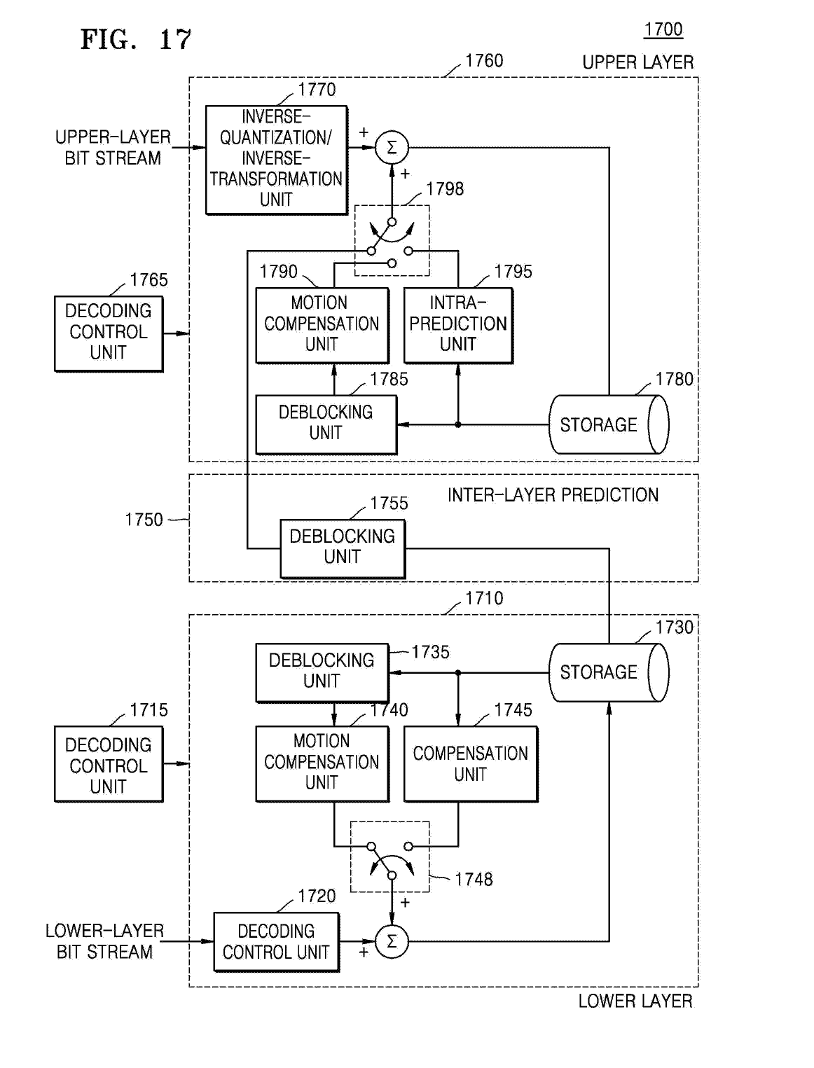

FIG. 17 is a block diagram of a scalable decoding apparatus 1700 according to an exemplary embodiment.

The scalable decoding apparatus 1700 includes a lower-layer decoding apparatus 1710 (e.g., lower-layer decoder) and an upper-layer decoding apparatus 1760 (e.g., upper-layer decoder). The lower-layer decoding apparatus 1710 and the upper-layer decoding apparatus 1760 may correspond respectively to the lower-layer coding unit 1520 and the upper-layer coding unit 1530 of FIG. 15.

When the parsing unit 1510 parses the encoding information of the lower-layer image and the encoding information of the upper-layer image from the bit stream and outputs the parsed information, an inverse-quantization/inverse-transformation unit 1720 (e.g., inverse-quantizer/inverse-transformer) inverse-quantizes/inverse-transforms the residual of the lower-layer image and outputs the restored residual information. A motion compensation unit 1740 (e.g., motion compensator) outputs a prediction value by performing inter-prediction on the current block, and an intra-prediction unit 1745 (e.g., intra-predictor) outputs a prediction value by performing intra-prediction on the current block.

In particular, the motion compensation unit 1740 may acquire an accurate motion compensation prediction value by using a weighted sum of a block-based motion compensation prediction value and a pixel-unit motion compensation prediction value acquired in a motion compensation process. The motion compensation unit 1740 may determine the corresponding region of two reference pictures of the lower-layer block through bidirectional prediction and acquire the block-based motion compensation prediction value of the lower-layer block by using the average value of the corresponding region. Also, as described below, the motion compensation unit 1740 may acquire a displacement motion vector of each pixel by using two reference pictures of the lower-layer encoded current block and generate a pixel-unit motion compensation prediction value by using the acquired displacement motion vector and the gradient value acquired from the two reference pictures.

A decoding control unit 1715 (e.g., decoding controller) determines one of the intra-prediction mode and the inter-prediction mode based on the prediction mode information of the current block of the lower-layer image included in the encoding information of the lower-layer image and controls a prediction switch 1748 to output the prediction value according to the determined prediction mode. The current block of the lower layer is restored by adding the restored residual and the prediction value of the current block acquired through intra-prediction or inter-prediction. The restored lower-layer image is stored in a storage 1730. A deblocking unit 1735 (e.g., deblocker) performs deblocking filtering on the restored lower-layer image.

An inter-layer prediction apparatus 1750 (e.g., inter-layer predictor) outputs the lower-layer image information to the upper-layer decoding apparatus 1760 so that the lower-layer image may be used for prediction encoding of the upper-layer image. A deblocking unit 1755 (e.g., deblocker) of the inter-layer prediction apparatus 1750 performs deblocking filtering on the restored lower-layer image and outputs the filtered lower-layer image to the upper-layer decoding apparatus 1760.

The upper-layer decoding apparatus 1760 decodes the upper-layer image by using the encoding information of the lower-layer image decoded by the lower-layer encoding apparatus 1710. The upper-layer decoding apparatus 1760 may use the encoding information of the lower-layer image determined by the lower-layer decoding apparatus 1710 or may change the encoding information of the lower-layer image to determine the encoding information to be used for decoding of the upper-layer image.

An inverse-quantization/inverse-transformation unit 1770 (e.g., inverse-quantizer/inverse-transformer) inverse-quantizes/inverse-transforms the residual of the upper-layer image and outputs the restored residual information. A motion compensation unit 1790 (e.g., motion compensator) outputs a prediction value by performing inter-prediction on the current block of the upper layer, and an intra-prediction unit 1795 (e.g., intra-predictor) outputs a prediction value by performing intra-prediction on the current block of the upper layer. The motion compensation unit 1790 may determine the motion vector of the upper-layer current block by scaling the motion vector of the lower-layer block corresponding to the upper-layer current block, or may acquire the motion vector of the upper-layer current block based on the motion vector information of the upper-layer current block that is encoded independently from the motion vector of the corresponding block of the lower layer and included in the bit stream.

In particular, the motion compensation unit 1790 of the upper layer may acquire a motion compensation prediction value of the upper-layer current block by using a weighted sum of a prediction value of the corresponding block of the lower layer corresponding to the current block of the upper layer and a motion compensation prediction value of the current block of the upper layer. The motion compensation prediction value of the current block of the upper layer may be acquired by using a weighted sum of a pixel-unit motion compensation prediction value and a block-unit prediction value according to the block-unit motion compensation result of the current block. The pixel-unit motion compensation prediction value may be acquired by using the displacement motion vector of each pixel, which is acquired by using two reference pictures of the current block of the bidirectionally-predicted upper layer and the corresponding block of the lower layer corresponding to the current block, and the gradient value acquired from the two reference pictures.

A decoding control unit 1765 (e.g., decoding controller) determines one of the intra-prediction mode and the inter-prediction mode based on the prediction mode information included in the encoding information of the lower-layer image and controls a prediction switch 1798 to output the prediction block according to the determined prediction mode. The current prediction unit is restored by adding the restored residual and the prediction value of the upper-layer current prediction unit acquired through intra-prediction or inter-prediction. The restored lower-layer image is stored in a storage 1780. A deblocking unit 1785 (e.g., deblocker or deblocking filterer) performs deblocking filtering on the restored lower-layer image.

Hereinafter, a motion compensation process performed by the motion compensation unit 425 of FIG. 4, the motion compensation units 1640 and 1690 of FIG. 16, and the motion compensation units 1740 and 1790 of FIG. 17 will be described in detail.

The related art motion prediction and compensation method uses a block matching algorithm that uses a square block of a predetermined size (e.g., a 16×16-sized macro-block) to select a region, which is most similar to a macro-block that is currently encoded in a reference frame, to generate a prediction value. For example, the related art bidirectional motion prediction and compensation method detects a region, which is most similar to the current block encoded in the previous frame P0 and the next frame P1, and generates a prediction value of the current block by using the average value of the corresponding pixels of the region detected in the previous frame P0 and the region detected in the next frame P1.

The related art block-based motion prediction and compensation method may detect motions relatively accurately in most video sequences. However, when there is a small-motion portion in the block, the related art block-based motion prediction and compensation method has difficulty in efficiently predicting the small-motion portion because it performs prediction and compensation with respect to the entire block. However, performing pixel-unit motion prediction and compensation in order to predict a small motion in the block is inefficient because it excessively increases the bit rate required to encode the motion vector information of each pixel. Thus, the motion compensation method according to exemplary embodiments provides a method for additionally performing pixel-unit bidirectional motion compensation based on the block-based bidirectional motion prediction and compensation results without increasing the bit rate required to encode the motion information.

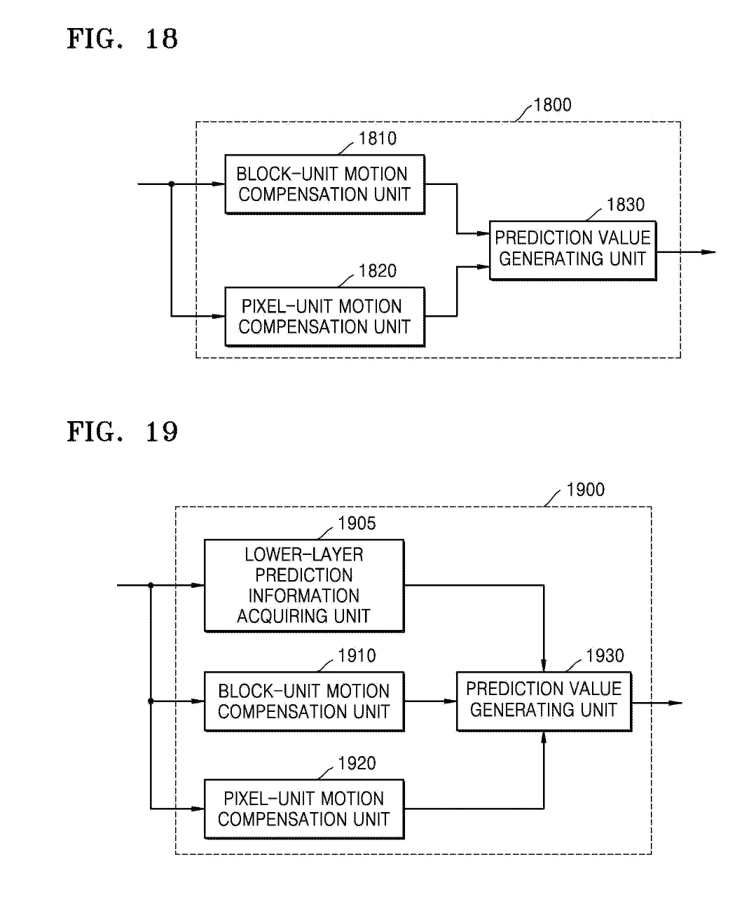

FIG. 18 is a block diagram of a motion compensation unit according 1800 to an exemplary embodiment. A motion compensation unit 1800 of FIG. 18 performs motion compensation in a video of a single layer. The motion compensation unit 1800 of FIG. 18 performs motion compensation by using only information of the current layer without using video information of other layers. For example, the motion compensation unit 1800 of FIG. 18 may be used in the motion compensation unit 425 of FIG. 4, the motion compensation unit 560 of FIG. 5, the lower-layer motion compensation unit 1640 of FIG. 16, and the lower-layer motion compensation unit 1740 of FIG. 17. If motion compensation is performed on the upper layer independently from the lower layer in the scalable video, that is, without using information of the lower layer, the motion compensation unit 1800 of FIG. 18 may be used in the upper-layer motion compensation unit 1649 of FIG. 16, and the upper-layer motion compensation unit 1790 of FIG. 17.

Referring to FIG. 18, the motion compensation unit 1800 according to an exemplary embodiment includes a block-unit motion compensation unit 1810 (e.g., block-unit motion compensator), a pixel-unit motion compensation unit 1820 (e.g., pixel-unit motion compensator), and a prediction value generating unit 1830 (e.g., prediction value generator).

The block-unit motion compensation unit 1810 performs block-unit bidirectional motion compensation on the current block by using the bidirectional motion vectors acquired from the bidirectional motion prediction results about the current block.

The pixel-unit motion compensation unit 1820 additionally performs pixel-unit motion compensation on each pixel of the current block that is motion-compensated on a block-by-block basis by using the pixels of the reference pictures indicated by the bidirectional motion vectors.

The prediction value generating unit 1830 generates the final bidirectional motion prediction value of the current block by using the block-unit bidirectional motion compensation result and the pixel-unit motion compensation result.

FIG. 19 is a block diagram of a motion compensation unit 1900 according to another exemplary embodiment. A motion compensation unit 1900 of FIG. 19 is used to perform motion compensation in a video including a plurality of layers. The motion compensation unit 1900 of FIG. 19 performs motion compensation on a video of the current layer by using the encoding information of another layer that is previously encoded and then restored. For example, the motion compensation unit 1800 of FIG. 18 may be used in the upper-layer motion compensation unit 1690 of FIG. 16 and the upper-layer motion compensation unit 1790 of FIG. 17.

Referring to FIG. 19, the motion compensation unit 1900 according to another exemplary embodiment includes a lower-layer prediction information acquiring unit 1905 (e.g., lower-layer prediction information acquirer), a block-unit motion compensation unit 1910 (e.g., block-unit motion compensator), a pixel-unit motion compensation unit 1920 (e.g., pixel-unit motion compensator), and a prediction value generating unit 1930 (e.g., prediction value generator).

The lower-layer prediction information acquiring unit 1905 acquires a prediction value of each pixel constituting the current block from the corresponding block of the lower layer corresponding to the current block of the encoded upper layer. If the upper-layer image has a higher resolution than the lower-layer image, the lower-layer prediction information acquiring unit 1905 may up-sample the corresponding block of the lower layer previously restored and use the result value as the prediction value of the current block of the upper layer.

The block-unit motion compensation unit 1910 performs block-unit bidirectional motion compensation on the current block by using the bidirectional motion vectors of the current block of the upper layer. The block-unit motion compensation unit 1910 acquires a first motion vector indicating a first corresponding block of a first reference picture referenced by the current block and a second motion vector indicating a second corresponding block of a second reference picture and performs block-unit bidirectional motion compensation on the current block by using the first motion vector and the second motion vector. That is, the block-unit motion compensation unit 1910 may use the average value of the pixels of the corresponding regions of the reference pictures indicated by the first motion vector and the second motion vector, as the block-unit bidirectional motion compensation prediction value of each pixel of the current block. The motion vector used for bidirectional motion compensation of the current block of the upper layer may be determined by using the motion vector of the corresponding block of the lower layer, or may be determined independently from the motion vector of the corresponding block of the lower layer.

The pixel-unit motion compensation unit 1920 additionally performs pixel-unit motion compensation on each pixel of the current block that is bidirectionally motion-compensated on a block-by-block basis by using the pixels of the reference pictures indicated by the bidirectional motion vectors. The pixel-unit motion compensation prediction value may be acquired by using the displacement motion vector of each pixel, which is acquired by using two reference pictures of the current block of the bidirectionally-predicted upper layer and the corresponding block of the lower layer corresponding to the current block, and the gradient value acquired from the two reference pictures. A pixel-unit motion compensation process will be described in detail below.

The prediction value generating unit 1930 may acquire a motion compensation prediction value of the current block of the upper layer by using a weighted sum of a motion compensation prediction value of the current block of the upper layer and a prediction value of the corresponding block of the lower layer corresponding to the current block of the upper layer. The motion compensation prediction value of the current block of the upper layer is acquired by using a weighted sum of a pixel-unit motion compensation prediction value and a block-unit prediction value according to the block-unit motion compensation result of the current block.

Hereinafter, a block-unit bidirectional motion prediction and compensation process and a pixel-unit bidirectional motion compensation process according to an exemplary embodiment will be described in detail. First, a process of performing motion compensation by using an image of a single layer will be described. For example, the process of performing motion compensation by using an image of a single layer described below may be applied to a bidirectional motion compensation process for an image of the base layer.

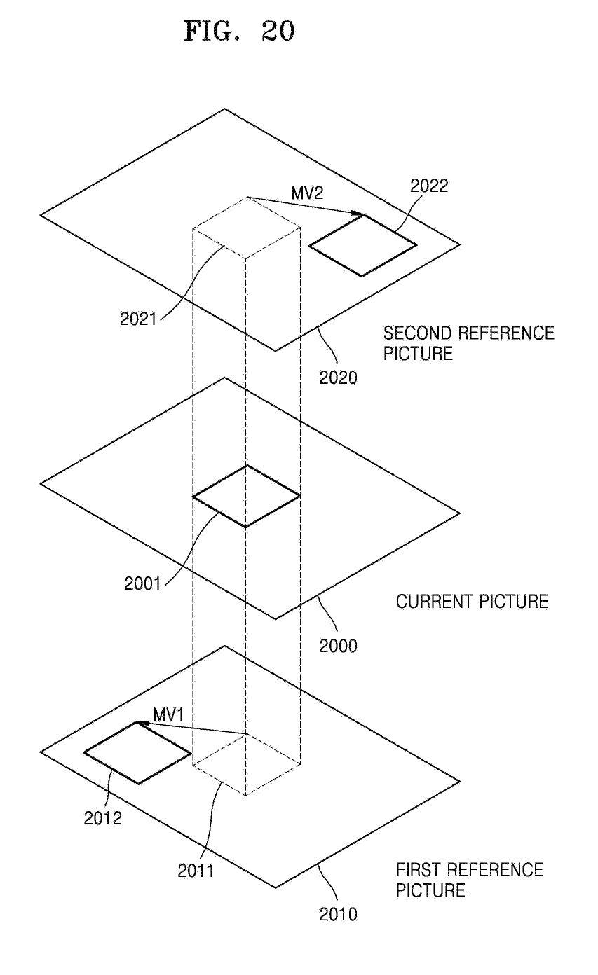

FIG. 20 is a reference diagram illustrating block-based bidirectional motion prediction and compensation processes according to an exemplary embodiment.

Referring to FIGS. 18 and 20, it is assumed that motion vectors MV1 and MV2 indicating corresponding regions 2011 and 2021 that is most similar to an encoded current block 2001 of a current picture 2000 in a first reference picture 2010 and a second reference picture 2020 have been determined by bidirectional motion prediction of the current block 2001. The decoding side may determine the bidirectional motion vectors MV1 and MV2 from the motion vector information included in the bit stream.

The block-unit motion compensation unit 1810 performs block-unit bidirectional motion compensation on the current block 2001 by using the first motion vector MV1 and the second motion vector MV2. For example, when a pixel value of the first reference picture 2010 located at (i,j) (where i and j are integers) is P0(i,j) and a pixel value of the second reference picture 2020 located at (i,j) is P1(i,j), MV1=(MVx1,MVy1), MV2=(MVx2, MVy2), a block-unit bidirectional motion compensation prediction value P_BiPredBlock(i,j) of a (i,j)-position pixel of the current block 2001 may be calculated as an equation P_BiPredBlock(i,j)={P0(i+MV×1, j+MVy1)+P1(i+MVx2, j+MVy2)}/2. In this manner, the block-unit motion compensation unit 1810 performs block-unit motion compensation on the current block 2001 by using the weighted sum or the average value of the pixels of the first corresponding region 2012 and the second corresponding region 2022 indicated by the first motion vector MV1 and the second motion vector MV2.

The pixel-unit motion compensation unit 1820 performs pixel-unit motion compensation on the current block 2001 based on an optical flow of the pixels of the first reference picture 2010 and the second reference picture 2020.

The optical flow represents the pattern of apparent motion of an object induced by the relative motion between an observer (eye or camera) and a scene. In a video sequence, the optical flow may be acquired by calculating a change in the brightness value or the pixel value between the frames acquired at times t and t+Δt. A pixel value located at (x,y) of the t-time frame is defined as I(x,y,t). I(x,y,t) is a value that changes temporally and spatially. When I(x,y,t) is differentiated for the time t, Equation 1 below is obtained.

$$\frac{d I}{d t} = \frac{\partial I}{\partial x} \frac{d x}{d t} + \frac{\partial I}{\partial y} \frac{d y}{d t} + \frac{\partial I}{\partial t} \qquad Equation 1$$

If a change of the pixel value by motion exists in a small motion portion in the block but the pixel value does not change with time, dl/dt is 0. Also, if dx/dt is defined as an x-axis displacement vector Vx of the pixel value I(x,y,t) and dy/dt is defined as a y-axis displacement vector Vy of the pixel value I(x,y,t), Equation 1 may be expressed as Equation 2.

$$\frac{\partial I}{\partial t} + Vx \cdot \frac{\partial I}{\partial x} + Vy \cdot \frac{\partial I}{\partial y} = 0 \qquad Equation 2$$

Herein, the sizes of the x-axis displacement vector Vx and the y-axis displacement vector Vy may be smaller than the pixel accuracy used in bidirectional motion prediction. For example, when the pixel accuracy has a value of ¼ in bidirectional motion prediction, the sizes of Vx and Vy may be smaller than ¼.

The pixel-unit motion compensation unit 1820 according to an exemplary embodiment calculates the x-axis displacement vector Vx and the y-axis displacement vector Vy according to Equation 2 and performs pixel-unit motion compensation by using the displacement vectors Vx and Vy. Since the pixel value I(x,y,t) is a value of the original signal in Equation 2, the use of the value of the original signal as it is may cause a lot of overhead in an encoding process. Thus, the pixel-unit motion compensation unit 1820 calculates the displacement vectors Vx and Vy according to Equation 2 by using the pixels of the first reference picture and the second reference picture determined by the block-unit bidirectional motion prediction result.

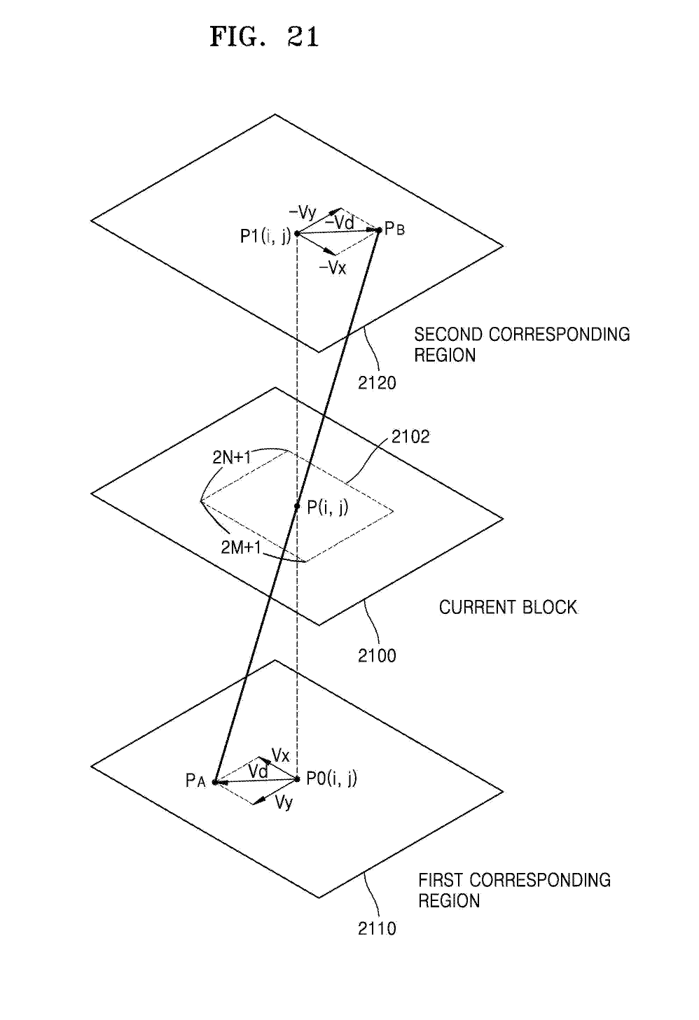

FIG. 21 is a reference diagram illustrating a process of performing pixel-unit motion compensation according to an exemplary embodiment.

In FIG. 21, a first corresponding region 2110 and a second corresponding region 2120 correspond to the first corresponding region 2012 and the second corresponding region 2022 of FIG. 20. That is, in FIG. 21, it is assumed that, by using the motion vectors MV1 and MV2, the first corresponding region 2110 and the second corresponding region 2120 are shifted to overlap a current block 2100. Also, the pixel of the bidirectionally-predicted (i,j) position of the current block 2100 is defined as P(i,j), the pixel value of the first corresponding pixel of the first reference picture corresponding to the bidirectionally-predicted pixel P(i,j) of the current block 2100 is defined as P0(i,j), and the pixel value of the second corresponding pixel of the second reference picture corresponding to the bidirectionally-predicted pixel P(i,j) of the current block 2100 is defined as P1(i,j). In other words, the pixel value P0(i,j) of the first corresponding pixel is the pixel corresponding to the pixel P(i,j) of the current block 2100 determined by the bidirectional motion vector MV1 indicating the first reference picture, and the pixel value P1(i,j) of the second corresponding pixel is the pixel corresponding to the pixel P(i,j) of the current block 2100 determined by the bidirectional motion vector MV2 indicating the second reference picture.

Also, the horizontal gradient value of the first corresponding pixel is defined as GradX0(i,j), the vertical gradient value thereof is defined as GradY0(i,j), the horizontal gradient value of the second corresponding pixel is defined as GradX1(i,j), and the vertical gradient value thereof is defined as GradY1(i,j). Also, a temporal distance between the current picture including the current block 2100 and the first reference picture including the first corresponding region 2110 is defined as d0, and a temporal distance between the current picture and the second reference picture including the second corresponding region 2120 is defined as d1.

Assuming that d0 and d1 is 1, in Equation 2,

$$\frac{\partial I}{\partial t}$$

may be approximated as a time-dependent variation of the pixel value P0(i,j) of the first corresponding pixel and the pixel value P1(i,j) of the second corresponding pixel, as expressed in Equation 3 below.

$$\frac{\partial I}{\partial t} \approx ( p 0 ( i , j ) - p 1 ( i , j ) ) / 2 \qquad Equation 3$$

In Equation 2, the gradient values ∂I/∂x and ∂I/∂y may be respectively approximated as the average value of the horizontal gradient values of the first corresponding pixel and the second corresponding pixel and the average value of the vertical gradient values of the first corresponding pixel and the second corresponding pixel, as expressed in Equations 4 and 5 below.

$$\begin{matrix}\frac{\partial I}{\partial x} \approx ( GradX 0 ( i , j ) + GradX 1 ( i , j ) ) / 2 & Equation 4 \\ \frac{\partial I}{\partial y} \approx ( GradY 0 ( i , j ) + GradY 1 ( i , j ) ) / 2 & Equation 5\end{matrix}$$

Equation 2 may be arranged as Equation 6 below by using Equations 3 to 5.

P0(i,j)·P1(i,j)+Vx(i,j)·(GradX0(i,j)+GradX1(i,j))+Vy(i,j)·(GradY0(i,j)+GradY1(i,j))=0 Equation 6

In Equation 6, since the x-axis displacement vector Vx and the y-axis displacement vector Vy may change according to the position of the current pixel P(i,j) (that is, depend on (i,j)), they may be expressed as Vx(i,j) and Vy(i,j) respectively.

Assuming that a certain small motion exists in the current block in FIG. 21, it is assumed that the pixel of the first corresponding region 2110 of the first reference picture, which is most similar to the current pixel P(i,j) that is bidirectionally motion-compensated on a pixel-by-pixel basis, is not the first corresponding pixel P0(i,j) but the first displacement corresponding pixel PA that is generated by shifting the first corresponding pixel P0(i,j) by a predetermined displacement vector Vd. Since it is assumed that a certain small motion exists as described above, the pixel that is most similar to the current pixel P(i,j) in the second corresponding region 2120 of the second reference picture may be estimated as the second displacement corresponding pixel PB that is generated by shifting the second corresponding pixel P1(i,j) by −Vd. The displacement vector Vd is equal to Vd=(Vx, Vy) constituted by the x-axis displacement vector Vx and the y-axis displacement vector Vy. Thus, the pixel-unit motion compensation unit 1820 according to an exemplary embodiment calculates the x-axis displacement vector Vx and the y-axis displacement vector Vy constituting the displacement vector Vd and performs pixel-unit motion compensation on the value obtained by block-unit bidirectional motion compensation by using the displacement vector.

The values of the first displacement corresponding pixel PA and the second displacement corresponding pixel PB may be defined as Equations 7 and 8 below by using the x-axis displacement vector Vx, the y-axis displacement vector Vy, the horizontal gradient value GradX0(i,j) of the first corresponding pixel, the vertical gradient value GradY0(i,j) thereof, the horizontal gradient value GradX1(i,j) of the second corresponding pixel, and the vertical gradient value GradY1(i,j) thereof.

PA=P0(i,j)+Vx(i,j)·GradX0(i,j)+Vy(i,j)·GradY0(i,j) Equation 7

PB=P1(i,j)−Vx(i,j)·GradX1(i,j)−Vy(i,j)·GradY1(i,j) Equation 8

When the difference value between the first displacement corresponding pixel PA and the second displacement corresponding pixel PB is Δij, Δij is expressed as Equation 9 below.

Δij=PA·PB=P0(i,j)·P1(i,j)+Vx(i,j)·(GradX0(i,j)+GradX1(i,j))+Vy(i,j)·(GradY0(i,j)+GradY1(i,j)) Equation 9

By comparison between Equations 6 and 9, when Δij is 0, Equation 6 represents the case where the first displacement corresponding pixel PA and the second displacement corresponding pixel PB have the same value.

The pixel-unit motion compensation unit 1820 performs pixel-unit motion compensation by using the weighted sum or the average of the values of the first displacement corresponding pixel PA and the second displacement corresponding pixel PB in Equations 7 and 8. In order to calculate Equations 7 and 8, the x-axis displacement vector Vx, the y-axis displacement vector Vy, the horizontal gradient value GradX0(i,j) of the first corresponding pixel, the vertical gradient value GradY0(i,j) thereof, the horizontal gradient value GradX1(i,j) of the second corresponding pixel, and the vertical gradient value GradY1(i,j) thereof should be determined. As described below, the gradient values of the first corresponding pixel and the second corresponding pixel may be determined by calculating the variations of the pixel values of the first corresponding pixel and the second corresponding pixel at the sub-pixel position in the horizontal and vertical directions, or may be calculated by using a predetermined filter.

First, a process of determining the x-axis displacement vector Vx and the y-axis displacement vector Vy will be described.

The pixel-unit motion compensation unit 1820 determines the x-axis displacement vector Vx and the y-axis displacement vector Vy for minimizing Δij within a window (Ωij) 2102 of a predetermined size including adjacent pixels around the current pixel P(i,j) that is bidirectionally motion-compensated. The case of Δij being 0 may be most preferable. However, since the x-axis displacement vector Vx and the y-axis displacement vector Vy satisfying the case of Δij being 0 may not exist for all the pixels in the window (Ωij) 2102, the x-axis displacement vector Vx and the y-axis displacement vector Vy for minimizing Δij are determined.

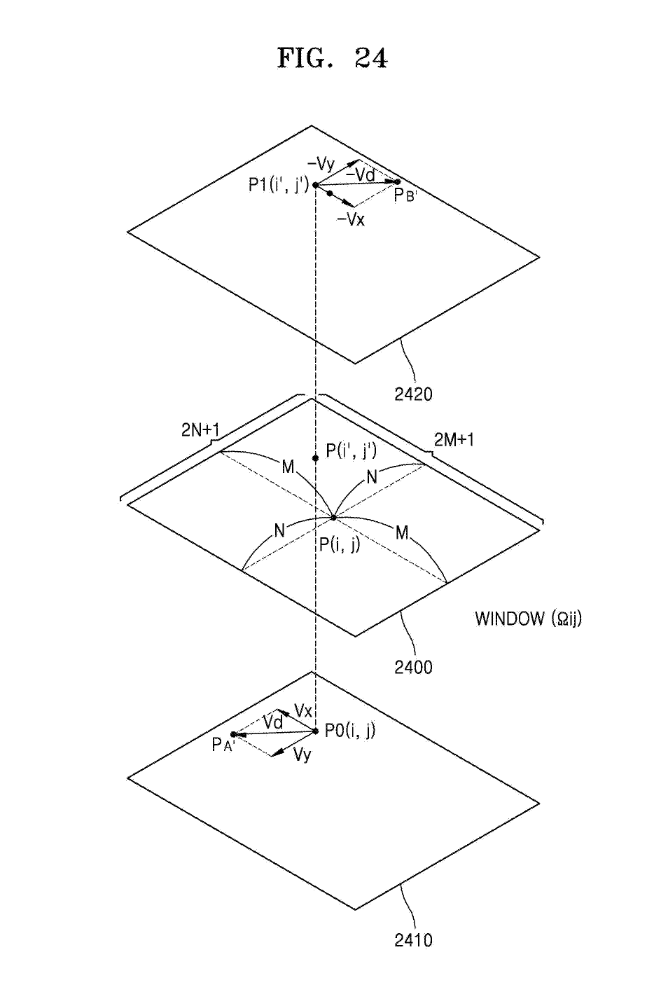

FIG. 24 is a reference diagram illustrating a process of determining a horizontal displacement vector and a vertical displacement vector according to an exemplary embodiment.

Referring to FIG. 24, a window (Ωij) 2400 of a predetermined size has a size of (2M+1)*(2N+1) (where M and N are integers) around the bidirectionally-predicted pixel P(i,j) of the current block. A reference numeral ‘2410’ denotes a region corresponding to the window 2400 of the current picture in the first reference picture, a reference numeral ‘2420’ denotes a region corresponding to the window 2400 of the current picture in the second reference picture. As the size of the window (Ωij) 2400 increases, the more accurate displacement motion vector may be acquired but the operation amount increases. Thus, it may be preferable that the window (Ωij) 2400 has a size of 5×5 according to (2M+1)*(2N+1) (N=M=2). However, the size of the window is not limited thereto and may change in consideration of the performance of hardware. When the pixel of the bidirectionally-predicted current block in the window is P(i′,j′) (if i−M≦i′≦i+M and j−M≦j′≦j+M, then (i′,j′) ∈ Ωij), the pixel value of the first corresponding pixel of the first reference picture 2410 corresponding to the bidirectionally-motion-compensated pixel P(i′,j′) of the current block is P0(i′,j′), the pixel value of the second corresponding pixel of the second reference picture 2420 corresponding to the bidirectionally-motion-compensated pixel P(i′,j′) of the current block is P1(i′,j′), the horizontal gradient value of the first corresponding pixel is GradX0(i′,j′), the vertical gradient value thereof is GradY0(i′,j′), the horizontal gradient value of the second corresponding pixel is GradX1(i′,j′), and the vertical gradient value thereof is GradY1(i′,j′), the first displacement corresponding pixel PA′ has a value of an equation P0(i′,j′)+Vx*GradX0(i′,j′)+Vy*GradY0(i′,j′) and the second displacement corresponding pixel PB′ has a value of an equation P1(i′,j′)−Vx*GradX1(i′,j′)−Vy*GradY1(i′,j′).

The x-axis displacement vector Vx and the y-axis displacement vector Vy for minimizing Δij that is a difference value between the first displacement corresponding pixel PA′ and the second displacement corresponding pixel PB′ may be determined as Equation 10 below by using the maximum value or minimum value of Φ(Vx,Vy) that is a square sum of a difference value Δi′j′ acquired for each pixel in the window (106 ij) 2400.

$$Φ ( Vx , Vy ) = {\sum }_{{i}^{′} , {j}^{′} ∈ Ω ij} {Δ}_{{i}^{′} {j}^{′}}^{2} = {\sum }_{{i}^{′} , {j}^{′} ∈ Ω ij} {( \begin{matrix}\begin{matrix}P 0 ( {i}^{′} , {j}^{′} ) - P 1 ( {i}^{′} , {j}^{′} ) + Vx ( i , j ) \cdot \\ ( GradX 0 ( {i}^{′} , {j}^{′} ) + GradX 1 ( {i}^{′} , {j}^{′} ) ) +\end{matrix} \\ \begin{matrix}Vy ( i , j ) \cdot \\ ( GradY 0 ( {i}^{′} , {j}^{′} ) + GradY 1 ( {i}^{′} , {j}^{′} ) )\end{matrix}\end{matrix} )}^{2} = {\sum }_{{i}^{′} , {j}^{′} ∈ Ω ij} [ {( P 0 ( {i}^{′} , {j}^{′} ) - P 1 ( {i}^{′} , {j}^{′} ) )}^{2} + {Vx}^{2} ( i , j ) \cdot {( GradX 0 ( {i}^{′} , {j}^{′} ) + GradX 1 ( {i}^{′} , {j}^{′} ) )}^{2} + {Vy}^{2} ( i , j ) \cdot {( GradY 0 ( {i}^{′} , {j}^{′} ) + GradY 1 ( {i}^{′} , {j}^{′} ) )}^{2} + 2 Vx ( i , j ) \cdot ( GradX 0 ( {i}^{′} , {j}^{′} ) + GradX 1 ( {i}^{′} , {j}^{′} ) ) \cdot ( P 0 ( {i}^{′} , {j}^{′} ) - P 1 ( {i}^{′} , {j}^{′} ) ) + 2 Vy ( i , j ) \cdot ( GradY 0 ( {i}^{′} , {j}^{′} ) + GradY 1 ( {i}^{′} , {j}^{′} ) ) \cdot ( P 0 ( {i}^{′} , {j}^{′} ) - P 1 ( {i}^{′} , {j}^{′} ) ) + 2 Vx ( i , j ) \cdot ( GradX 0 ( {i}^{′} , {j}^{′} ) + GradX 1 ( {i}^{′} , {j}^{′} ) ) \cdot ( GradY 0 ( {i}^{′} , {j}^{′} ) + GradY 1 ( {i}^{′} , {j}^{′} ) ) ] \qquad Equation 10$$

Φ(Vx,Vy) is a function having parameters Vx and Vy, and the maximum value or minimum value thereof may be determined by calculating a value that causes a partial differentiation of Φ(Vx,Vy) for Vx and Vy to be 0 as expressed in Equations 11 and 12 below.

$$\begin{matrix}\frac{\partial Φ ( Vx , Vy )}{\partial Vx} = {\sum }_{{i}^{′} , {j}^{′} ∈ Ω ij} [ 2 Vx ( i , j ) \cdot {( GradX 0 ( {i}^{′} , {j}^{′} ) + GradX 1 ( {i}^{′} , {j}^{′} ) )}^{2} + 2 ( GradX 0 ( {i}^{′} , {j}^{′} ) + GradX 1 ( {i}^{′} , {j}^{′} ) ) \cdot ( P 0 ( {i}^{′} , {j}^{′} ) - P 1 ( {i}^{′} , {j}^{′} ) ) + 2 ( GradX 0 ( {i}^{′} , {j}^{′} ) + GradX 1 ( {i}^{′} , {j}^{′} ) ) \cdot Vy ( i , j ) \cdot ( GradY 0 ( {i}^{′} , {j}^{′} ) + GradY ( {i}^{′} , {j}^{′} ) ) ] = 0 & Equation 11 \\ \frac{\partial Φ ( Vx , Vy )}{\partial Vy} = {\sum }_{{i}^{′} , {j}^{′} ∈ Ω ij} [ 2 Vy ( i , j ) \cdot {( GradY 0 ( {i}^{′} , {j}^{′} ) + GradY 1 ( {i}^{′} , {j}^{′} ) )}^{2} + 2 ( GradY 0 ( {i}^{′} , {j}^{′} ) + GradY 1 ( {i}^{′} , {j}^{′} ) ) \cdot ( P 0 ( {i}^{′} , {j}^{′} ) - P 1 ( {i}^{′} , {j}^{′} ) ) + 2 ( GradX 0 ( {i}^{′} , {j}^{′} ) + GradX 1 ( {i}^{′} , {j}^{′} ) ) \cdot Vx ( i , j ) \cdot ( GradY 0 ( {i}^{′} , {j}^{′} ) + GradY 1 ( {i}^{′} , {j}^{′} ) ) ] = 0 & Equation 12\end{matrix}$$

Two linear equations having variables Vx(i,j) and Vy(i,j) may be acquired from Equations 11 and 12 as expressed in Equation 13 below.

Vx(i,j)·s1+Vy(i,j)·s2=s3;

Vx(i,j)·s4+Vy(i,j)·s5=s6 Equation 13

In Equation 13, s1 to s6 are expressed as Equation 14 below.

$$s 1 = {\sum }_{{i}^{′} , {j}^{′} ∈ {Ω}_{i , j}} {( GradX 0 ( {i}^{′} , {j}^{′} ) + GradX 1 ( {i}^{′} , {j}^{′} ) )}^{2} \\ s 2 = s 4 = {\sum }_{{i}^{′} , {j}^{′} ∈ {Ω}_{i , j}} ( GradX 0 ( {i}^{′} , {j}^{′} ) + GradX 1 ( {i}^{′} , {j}^{′} ) ) ( GradY 0 ( {i}^{′} , {j}^{′} ) + GradY 1 ( {i}^{′} , {j}^{′} ) ) \\ s 3 = - {\sum }_{{i}^{′} , {j}^{′} ∈ {Ω}_{i , j}} ( P 0 ( {i}^{′} , {j}^{′} ) - P 1 ( {i}^{′} , {j}^{′} ) ) ( GradX 0 ( {i}^{′} , {j}^{′} ) + GradX 1 ( {i}^{′} , {j}^{′} ) ) \\ s 5 = {\sum }_{{i}^{′} , {j}^{′} ∈ {Ω}_{i , j}} {( GradY 0 ( {i}^{′} , {j}^{′} ) + GradY 1 ( {i}^{′} , {j}^{′} ) )}^{2} \\ s 6 = - {\sum }_{{i}^{′} , {j}^{′} ∈ {Ω}_{i , j}} ( P 0 ( {i}^{′} , {j}^{′} ) - P 1 ( {i}^{′} , {j}^{′} ) ) ( GradY 0 ( {i}^{′} , {j}^{′} ) + GradY 1 ( {i}^{′} , {j}^{′} ) ) \qquad Equation 14$$

When simultaneous equations of Equation 13 are solved, the values of Vx(i,j) and Vy(i,j) may be calculated as Vx(i,j)=det1/det and Vy(i,j)=det2/det according to Kramer's Formulas. Herein, det1=s3*s5−s2*s6, det2=s1*s6−s3*s4, and det=s1*s5−s2*s4.

In terms of hardware, an operation of calculating det1, det2, and det to acquire Vx(i,j) and Vy(i,j) is complex and requires a large amount of operation. Thus, the horizontal displacement vector Vx(i,j) for the current pixel of the (i,j) position may use an approximated value like Vx(i,j)=s3/s1, and the vertical displacement vector Vy(i,j) thereof may use an approximated value of Vy(i,j)=(s6−Vx*s2)/s4 instead. When such approximated values are used, the horizontal displacement vector Vx(i,j) and the vertical displacement vector Vy(i,j) of the current pixel may be acquired through 32-bit integer operation without an overflow.

Referring to FIG. 18, the prediction value generating unit 1830 generates a bidirectional motion prediction value by adding a block-unit bidirectional motion compensation prediction value and a pixel-unit motion compensation prediction value. In detail, when the bidirectional motion prediction value for the pixel of the (i,j) position of the current block is P_{BIO}(i,j), the pixel value of the first corresponding pixel of the first reference picture corresponding to the pixel of the (i,j) position of the current block is P0(i,j), the pixel value of the first corresponding pixel of the first reference picture corresponding to the pixel of the (i,j) position of the current block is P0(i,j), the horizontal gradient value of the first corresponding pixel of the first reference picture is GradX0(i,j), the vertical gradient value thereof is GradY0(i,j), the pixel value of the second corresponding pixel of the second reference picture corresponding to the pixel of the (i,j) position of the current block is P1(i,j), the horizontal gradient value of the second corresponding pixel of the second reference picture is GradX1(i,j), the vertical gradient value thereof is GradY1(i,j), the horizontal displacement vector is Vx, and the vertical displacement vector is Vy, the prediction value generating unit 1830 generates a bidirectional motion prediction value as Equation 15 below.

$$P\_OpticalFlow ( i , j ) = ( P 0 ( i , j ) + P 1 ( i , j ) ) / 2 + ( Vx \cdot ( GradX 0 ( i , j ) - GradX 1 ( i , j ) ) + Vy \cdot ( GradY 0 ( i , j ) - GradY 1 ( i , j ) ) ) / 2 \qquad Equation 15$$

In Equation 15, (P0(i,j)+P1(i,j))/2 corresponds to the block-unit bidirectional motion compensation prediction value, and (Vx*(GradX0(i,j)−GradX1(i,j))+Vy*(GradY0(i,j)−GradY1(i,j)))/2 corresponds to the pixel-unit motion compensation prediction value calculated according to an exemplary embodiment.

By multiplying the pixel-unit motion compensation prediction value by a predetermined weight α, Equation 15 may be modified as Equation 16 below.

$$P\_OpticalFlow ( i , j ) = ( P 0 ( i , j ) + P 1 ( i , j ) ) / 2 + ( α Vx \cdot ( GradX 0 ( i , j ) - GradX 1 ( i , j ) ) + α Vy \cdot ( GradY 0 ( i , j ) - GradY 1 ( i , j ) ) ) / 2 \qquad Equation 16$$

The predetermined weight α may be smaller than 1, preferably, α=0.56±0.05.

Equation 13 is calculated on the assumption that the temporal distance d0 between the current picture and the first reference picture and the temporal distance d1 between the current picture and the second reference picture are all 1. If d0 and d1 are not 1, the size of the displacement vector Vd should be scaled in inverse proportion to d0 and d1. That is, when the displacement vector of the first reference picture indicating the first displacement corresponding pixel in the first corresponding pixel is (Vx0, Vy0) and the displacement vector of the second reference picture indicating the second displacement corresponding pixel in the second corresponding pixel is (Vx1, Vy1), d0*Vx1=−d1*Vx0 and d0*Vy1=−d1*Vy0. Vx and Vy may be calculated by calculating the maximum value and the minimum value by partially differentiating the function Φ(Vx,Vy) for Vx and Vy while assuming d=d1/d0. As described above, Vx(i,j)=det1/det, Vy(i,j)=det2/det; and det1=s3*s5−s2*s6, det2=s1*s6−s3*s4, det=s1*s5−s2*s4. Herein, the values of s1 to s6 are expressed as Equation 17 below.

$$s 1 = {\sum }_{{i}^{′} , {j}^{′} ∈ {Ω}_{i , j}} {( GradX 0 ( {i}^{′} , {j}^{′} ) + d \cdot GradX 1 ( {i}^{′} , {j}^{′} ) )}^{2} \\ s 2 = s 4 = {\sum }_{{i}^{′} , {j}^{′} ∈ {Ω}_{i , j}} ( GradX 0 ( {i}^{′} , {j}^{′} ) + d \cdot GradX 1 ( {i}^{′} , {j}^{′} ) ) ( GradY 0 ( {i}^{′} , {j}^{′} ) + d \cdot GradY 1 ( {i}^{′} , {j}^{′} ) ) \\ s 3 = - {\sum }_{{i}^{′} , {j}^{′} ∈ {Ω}_{i , j}} ( P 0 ( {i}^{′} , {j}^{′} ) - P 1 ( {i}^{′} , {j}^{′} ) ) ( GradX 0 ( {i}^{′} , {j}^{′} ) + d \cdot GradX 1 ( {i}^{′} , {j}^{′} ) ) \\ s 5 = {\sum }_{{i}^{′} , {j}^{′} ∈ {Ω}_{i , j}} {( GradY 0 ( {i}^{′} , {j}^{′} ) + d \cdot GradY 1 ( {i}^{′} , {j}^{′} ) )}^{2} \\ s 6 = - {\sum }_{{i}^{′} , {j}^{′} ∈ {Ω}_{i , j}} ( P 0 ( {i}^{′} , {j}^{′} ) - P 1 ( {i}^{′} , {j}^{′} ) ) ( GradY 0 ( {i}^{′} , {j}^{′} ) + d \cdot GradY 1 ( {i}^{′} , {j}^{′} ) ) \qquad Equation 17$$

Also, when the temporal distance d0 between the current picture and the first reference picture and the temporal distance d1 between the current picture and the second reference picture are not 1, Equation 16 is modified as Equation 18 below and the prediction value generating unit 1830 generates a bidirectional motion compensation prediction value according to Equation 18.

$$P\_OpticalFlow ( i , j ) = ( P 0 ( i , j ) + P 1 ( i , j ) ) / 2 + ( α Vx \cdot ( GradX 0 ( i , j ) - d \cdot GradX 1 ( i , j ) ) + α Vy \cdot ( GradY 0 ( i , j ) - d \cdot GradY 1 ( i , j ) ) ) / 2 \qquad Equation 18$$

Although the optical flow of Equation 2 is based on the assumption that a time-dependent pixel value change is 0, the pixel value may change with time. When the time-dependent pixel value change is q, Equation 2 is modified as Equation 19 below.

$$\frac{\partial I}{\partial t} + Vx \cdot \frac{\partial I}{\partial x} + Vy \cdot \frac{\partial I}{\partial y} = q \qquad Equation 19$$

Herein, the average of the difference between the pixel values of the first corresponding region and the second corresponding region may be used as the value of q. That is, q may be calculated as Equation 20 below.

$$q = \frac{{\sum }_{i , j ∈ block} P 1 ( i , j ) - P 0 ( i , j )}{2 \cdot Hor\_block \_Size \cdot ver\_block \_Size} \qquad Equation 20$$

Hor_block_size represents the horizontal size of the current block, and ver_block_size represents the vertical size of the current block. When Vx and Vy are calculated by using the P1(i,j)−q value considering the variation q of the pixel value instead of P1(i,j) in Equations 6 to 18, Vx(i,j)=det1/det, Vy(i,j)=det2/det; and det1=s3*s5−s2*s6, det2=s1*s6−s3*s4, det=s1*s5−s2*s4. Herein, the values of s1 to s6 are expressed as Equation 21 below.

$$s 1 = {\sum }_{{i}^{′} , {j}^{′} ∈ {Ω}_{i , j}} {( GradX 0 ( {i}^{′} , {j}^{′} ) + d \cdot GradX 1 ( {i}^{′} , {j}^{′} ) )}^{2} \\ s 2 = s 4 = {\sum }_{{i}^{′} , {j}^{′} ∈ {Ω}_{i , j}} ( GradX 0 ( {i}^{′} , {j}^{′} ) + d \cdot GradX 1 ( {i}^{′} , {j}^{′} ) ) ( GradY 0 ( {i}^{′} , {j}^{′} ) + d \cdot GradY 1 ( {i}^{′} , {j}^{′} ) ) \\ s 3 = - {\sum }_{{i}^{′} , {j}^{′} ∈ {Ω}_{i , j}} ( P 0 ( {i}^{′} , {j}^{′} ) - P 1 ( {i}^{′} , {j}^{′} ) - q ) ( GradX 0 ( {i}^{′} , {j}^{′} ) + d \cdot GradX 1 ( {i}^{′} , {j}^{′} ) ) \\ s 5 = {\sum }_{{i}^{′} , {j}^{′} ∈ {Ω}_{i , j}} {( GradY 0 ( {i}^{′} , {j}^{′} ) + d \cdot GradY 1 ( {i}^{′} , {j}^{′} ) )}^{2} \\ s 6 = - {\sum }_{{i}^{′} , {j}^{′} ∈ {Ω}_{i , j}} ( P 0 ( {i}^{′} , {j}^{′} ) - P 1 ( {i}^{′} , {j}^{′} ) - q ) ( GradY 0 ( {i}^{′} , {j}^{′} ) + d \cdot GradY 1 ( {i}^{′} , {j}^{′} ) ) \qquad Equation 17$$

Even if the time-dependent pixel value change is q, the prediction value generating unit 1830 may generate a bidirectional motion compensation prediction value according to Equation 18.

As described above, the horizontal and vertical gradient values may be calculated by calculating the variation of the pixel value at the sub-pixel position in the horizontal and vertical directions of the first corresponding pixel and the second corresponding pixel, or may be calculated by using a predetermined filter.

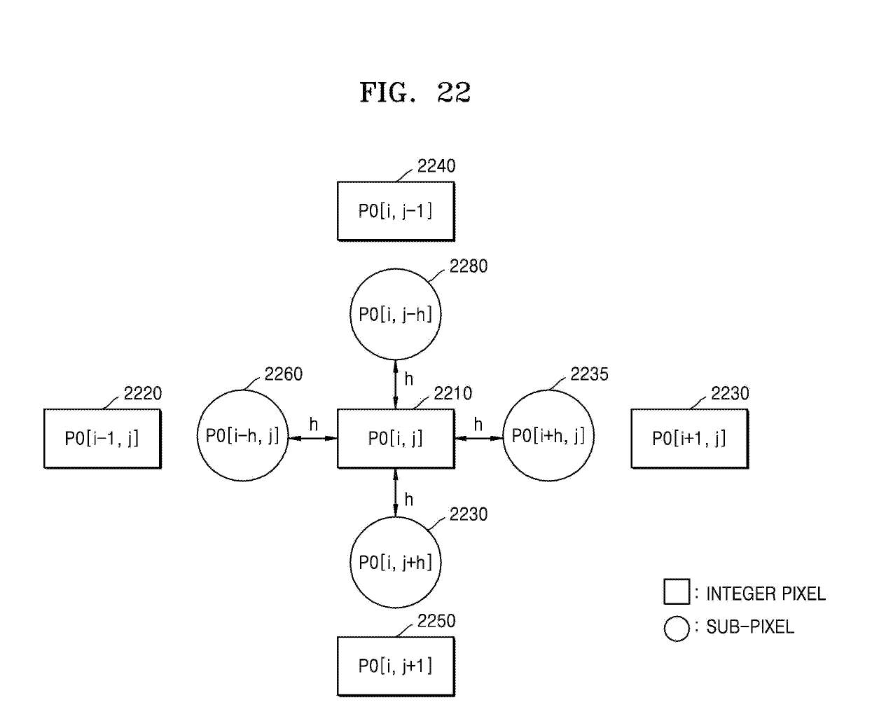

Referring to FIG. 22, the horizontal gradient value GradX0(i,j) and the vertical gradient value GradY0(i,j) of a first corresponding pixel P0(i,j) 2210 of the first reference picture may be calculated by calculating the variation of the pixel value at the adjacent sub-pixel position in the horizontal direction of the first corresponding pixel P0(i,j) 2210 and the variation of the pixel value at the adjacent sub-pixel position in the vertical direction thereof. That is, as expressed in Equation 22 below, the horizontal gradient value GradX0(i,j) may be calculated by calculating the variation of the pixel values of a sub-pixel P0(i−h,j) 2260 and a sub-pixel P0(i+h,j) 2270 spaced apart from P0(i,j) 2210 by h (where h is a sub-value smaller than 1) in the horizontal direction, and the vertical gradient value GradY0(i,j) may be calculated by calculating the variation of the pixel values of a sub-pixel P0(i,j−h) 2280 and a sub-pixel P0(i, j+h) 2235 spaced apart therefrom by h in the vertical direction.

GradX0(i,j)=(p0(i+h,j)−P0(i−h,j))/2h;

GradY0(i,j)=(p0(i,j+h)−P0(i,j−h))/2h Equation 22

The values of the sub-pixels P0(i−h,j) 2260, P0(i+h,j) 2270, P0(i,j−h) 2280, and P0(i, j+h) 2235 may be calculated by using a general interpolation method. Also, as in Equation 22, the horizontal gradient value GradX1(i,j) and the vertical gradient value GradY1(i,j) of the second corresponding value of the second reference pixel may be acquired by calculating the variation of the pixel value between the sub-pixels of the second reference pixel.

The gradient value of each corresponding pixel of the reference picture may be calculated by using a predetermined filter instead of by calculating the variation of the pixel value at the sub-pixel position as expressed in Equation 22.

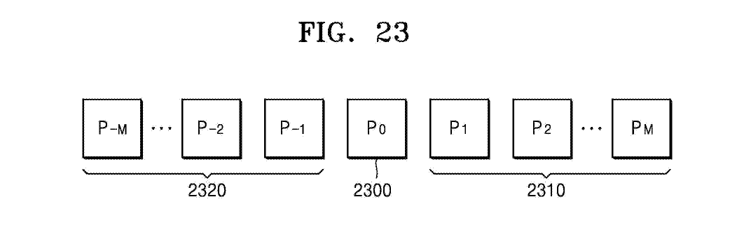

FIG. 23 is a reference diagram illustrating a process of calculating horizontal and vertical gradient values according to another exemplary embodiment.

According to another exemplary embodiment, the gradient value may be determined by applying a predetermined filter to the pixels of the reference picture. For example, referring to FIG. 23, the left and right sub-pixel values may be acquired by applying a predetermined filter to left pixels 2320 and right pixels 2310 around a corresponding pixel P0 2300 of which the current horizontal gradient value is to be calculated, and the horizontal gradient value of P0 2300 may be calculated by using the average value of the sub-pixel values. When the sub-pixel value located at h (where h is a real number between 0 and 1) on the left side of the corresponding pixel 2300 is DCT_Filter(h), and the sub-pixel value located at h on the right side thereof is DCT_Filter(−h), the horizontal gradient value of the corresponding pixel P0 2300 is acquired through {(DCT_Filter(h)−DCT_Filter(−h))}/(2h). Examples of filter tap coefficients Frac(h) used according to the position h of the sub-pixel are as follows:

Frac(0)={8, −39, −3, 46, −17, 5};

Frac(¼)={4, −17, −36, 60, −15, 4};

Frac(½)={−1, 4, −57, 57, −4, 1};

Frac(¾)={−4, 15, −60, 36, 17, 4}

Hereinafter, a bidirectional motion compensation process according to another exemplary embodiment will be described in detail. The bidirectional motion compensation process according to another exemplary embodiment is different from the above-described bidirectional motion compensation prediction value generating process according to an exemplary embodiment in that it is applied in the case of generating a bidirectional motion compensation prediction value of the upper-layer block by using both the currently-encoded upper-layer image data and the lower-layer image data that is previously encoded and then restored in the scalable video constituted by a plurality of layers.

As expressed in Equation 15 or 16, the bidirectional motion compensation prediction value according to an exemplary embodiment is acquired by calculating the sum or the weighted sum of the block-unit bidirectional motion compensation prediction value (P0(i,j)+P1(i,j))/2 and the pixel-unit motion compensation prediction value (Vx*(GradX0(i,j)−GradX1(i,j))+Vy*(GradY0(i,j)−GradY1(i,j)))/2. According to another exemplary embodiment, the first prediction value P_{BL} of each pixel constituting the current block is acquired from the corresponding block of the base layer corresponding to the current block of the enhancement layer, and the second prediction value P_{BIO} thereof is acquired by using the sum or the weighted sum of the block-unit bidirectional motion compensation prediction value and the pixel-unit bidirectional motion compensation prediction value by using the image data of the enhancement layer like the above-described bidirectional motion compensation prediction value according to an exemplary embodiment. Then, the bidirectional motion compensation prediction value of the enhancement-layer block is acquired by using the weighted sum of the first prediction value P_{BL} and the second prediction value P_{BIO}. As described below, the displacement vectors Vx and Vy of the reference pictures of the enhancement layer used to acquire the pixel-unit motion compensation prediction value constituting the second prediction value P_{BIO} is acquired by using both the image data of the enhancement layer and the corresponding block of the base layer corresponding to the current block of the enhancement layer. According to another exemplary embodiment, the horizontal gradient value GradX0(i,j) of the first corresponding pixel, the vertical gradient value GradY0(i,j) of the first corresponding pixel, the horizontal gradient value GradX1(i,j) of the second corresponding pixel, and the vertical gradient value GradY1(i,j) of the second corresponding pixel, which are necessary to acquire the pixel-unit motion compensation prediction value (Vx*(GradX0(i,j)−GradX1(i,j))+Vy*(GradY0(i,j)−GradY1(i,j)))/2, are acquired by using the image data of the enhancement layer in the same way as in the above-described exemplary embodiment. According to another exemplary embodiment, the first prediction value P_{BL} of each pixel constituting the current block is included in the motion compensation prediction value from the corresponding block of the base layer corresponding to the current block of the enhancement layer in order to acquire the final bidirectional motion compensation prediction value, and it is different from the bidirectional motion compensation method according to an exemplary embodiment in that the horizontal displacement vector Vx and the vertical displacement vector Vy of each pixel in the current block of the enhancement layer are acquired by using both the image data of the enhancement layer and the image data of the base layer.

Referring to FIG. 19, the lower-layer prediction information acquiring unit 1905 acquires a prediction value of each pixel constituting the current block from the corresponding block of the lower layer corresponding to the current block of the upper layer. The first prediction value predicted from the corresponding block of the lower layer corresponding to the current block of the upper layer is referred to as P_{BL}. The prediction value of the corresponding block of the lower block may be used as the first prediction value P_{BL}, or when the upper-layer image has a higher resolution than the lower-layer image, the corresponding block of the lower layer may be up-sampled and the resulting value may be used as the first prediction value P_{BL}. The up-sampled first prediction value P_{BL} may be acquired by using various interpolation methods.

The block-unit motion compensation unit 1910 performs block-unit bidirectional motion compensation on the current block by using the bidirectional motion vectors of the current block of the upper layer. The block-unit motion compensation unit 1910 acquires a first motion vector indicating a first corresponding block of a first reference picture of the enhancement layer referenced by the current block of the enhancement layer and a second motion vector indicating a second corresponding block of a second reference picture of the enhancement layer and performs block-unit bidirectional motion compensation on the current block of the enhancement layer by using the first motion vector and the second motion vector. The block-unit motion compensation unit 1910 may use the average value of the pixels of the corresponding regions of the reference pictures of the enhancement layer indicated by the first motion vector and the second motion vector, as the block-unit bidirectional motion compensation prediction value of each pixel of the current block of the enhancement layer. That is, when two motion vectors MV1 and MV2 acquired by the block unit of the enhancement layer are respectively MV1=(MVx1, MVy1) and MV2=(MVx2, MVy2), the block-unit bidirectional motion compensation prediction value P_BiPredBlock(i,j) of the current pixel of the (i,j) position of the enhancement layer may be acquired according to an equation P_BiPredBlock(i,j)={P0(i+MVx1, j+MVy1)+P1(i+MVx2, j+MVy2)}/2 by using the average value of the corresponding pixel P0(i+MVx1, j+MVy1) of the first reference picture and the corresponding pixel P1(i+MVx2, j+MVy2) of the second reference picture.

The motion vectors MV1 and MV2 used for bidirectional motion compensation of the current block of the enhancement layer may be determined by using the motion vector of the corresponding block of the lower layer. That is, the bidirectional motion vector of the current block of the enhancement layer may be determined by upscaling the motion vector of the corresponding block of the base layer. The motion vector of the current block of the enhancement layer may be determined independently from the motion vector of the corresponding block of the base layer.

The pixel-unit motion compensation unit 1920 performs pixel-unit motion compensation considering an optical flow on the reference pictures of the enhancement layer. That is, the pixel-unit motion compensation unit 1920 additionally performs pixel-unit motion compensation on each pixel of the current block that is bidirectionally motion-compensated on a block-by-block basis by using the pixels of the reference pictures of the enhancement layer indicated by the bidirectional motion vectors. In detail, the pixel-unit motion compensation unit 1920 acquires the horizontal gradient value GradX0(i,j) of the first corresponding pixel, the vertical gradient value GradY0(i,j) thereof, the horizontal gradient value GradX1(i,j) of the second corresponding pixel, and the vertical gradient value GradY1(i,j) thereof by using the first reference picture and the second reference picture of the enhancement layer, in order to calculate Δij that is a difference value between the first displacement corresponding pixel PA of the first reference picture of the enhancement layer and the second displacement corresponding pixel PB of the second reference picture of the enhancement layer corresponding to the current pixel P(i,j) that is bidirectionally motion-compensated by the pixel unit of the current block of the enhancement layer, as expressed in Equation 9. The horizontal gradient value GradX0(i,j) of the first corresponding pixel, the vertical gradient value GradY0(i,j) thereof, the horizontal gradient value GradX1(i,j) of the second corresponding pixel, and the vertical gradient value GradY1(i,j) thereof may be acquired by calculating the variation of the pixel value between the sub-pixels located in the horizontal and vertical directions around the corresponding pixel of the reference pictures as expressed in Equation 22, or by using a predetermined filter in the adjacent pixels around the corresponding pixel of the reference picture.

In order to calculate Δij of Equation 9, the pixel-unit motion compensation unit 1920 may additionally acquire the displacement motion vector of each pixel in the current block of the upper layer by using the corresponding block of the lower layer corresponding to the current block and two reference pictures referenced by the current block of the upper layer that is bidirectional predicted.

In detail, the second prediction value P_{BIO} acquired by using the sum or the weighted sum of the block-unit bidirectional motion compensation prediction value and the pixel-unit bidirectional motion compensation prediction value by using the image data of the enhancement layer is acquired through Equation 23 below like Equation 15.

$${P}_{BIO} ( i , j ) = ( P 0 ( i , j ) + P 1 ( i , j ) ) / 2 + ( Vx \cdot ( GradX 0 ( i , j ) - GradX 1 ( i , j ) ) + Vy \cdot ( GradY 0 ( i , j ) - GradY 1 ( i , j ) ) ) / 2 \qquad Equation 23$$

In Equation 23, (P0(i,j)+P1(i,j))/2 corresponds to the block-unit bidirectional motion compensation prediction value based on the reference pictures of the enhancement layer, and (Vx*(GradX0(i,j)−GradX1(i,j))+Vy*(GradY0(i,j)−GradY1(i,j)))/2 corresponds to the pixel-unit motion compensation prediction value acquired by using the reference pictures of the enhancement layer according to another exemplary embodiment. The horizontal and vertical displacement motion vectors Vx and Vy of each pixel in the current block of the upper layer are necessary to acquire the pixel-unit motion compensation prediction value of Equation 23.

As expressed in Equation 24 below, the pixel-unit motion compensation unit 1920 determines the displacement motion vectors Vx and Vy for minimizing a value (min) that is obtained by adding a square sum of a difference value Δij between a first displacement corresponding pixel PA and a second displacement corresponding pixel PB corresponding to the current pixel P(i,j), which is bidirectionally motion-compensated by the pixel unit of the current block of the enhancement layer, in a window (Ωij) region of a predetermined size determined by the motion-compensated current pixel in the current block of the enhancement layer and a value obtained by multiplying the square value of the difference value between the first prediction value P_{BL} and the second prediction value P_{BIO} by a predetermined weight a (where a is a real number).

$$min = {\sum }_{{i}^{′} , {j}^{′} ∈ Ω ij} {Δ}_{{i}^{′} {j}^{′}}^{2} + α * {( {P}_{BIO} ( {i}^{′} , {j}^{′} ) - {P}_{BL} ( {i}^{′} , {j}^{′} ) )}^{2} \qquad Equation 24$$

In Equation 24, when the pixel of the current block of the bidirectionally-motion-compensated enhancement layer in the window is P(i′,j′) (if i−M≦i′≦i+M and j−M≦j′≦j+M, then (i′,j′) ∈ Ωij), the pixel value of the first corresponding pixel of the first reference picture of the enhancement layer corresponding to the bidirectionally-motion-compensated pixel P(i′,j′) of the current block is P0(i′,j′), the pixel value of the second corresponding pixel of the second reference picture corresponding to the bidirectionally-motion-compensated pixel P(i′,j′) of the current block of the enhancement layer is P1(i′,j′), the horizontal gradient value of the first corresponding pixel is GradX0(i′,j′), the vertical gradient value thereof is GradY0(i′,j′), the horizontal gradient value of the second corresponding pixel is GradX1(i′,j′), and the vertical gradient value thereof is GradY1(i′,j′), the first displacement corresponding pixel PA has a value of an equation P0(i′,j′)+Vx*GradX0(i′,j′)+Vy*GradY0(i′,j′) and the second displacement corresponding pixel PB has a value of an equation P1(i′,j′)−Vx*GradX1(i′,j′)−Vy*GradY1(i′,j′). That is, as in Equation 9, in Equation 24, Δi′j′ is expressed as an equation Δi′j′=PA−PB=(P0(i′,j′)+Vx*GradX0(i′,j′)+Vy*GradY0(i′,j′))−(P1(i′,j′)−Vx*GradX1 (i′,j′)−Vy*G radY1(i′,j′)).

The ‘min’ of Equation 24 is a function having parameters Vx and Vy, and Vx and Vy for minimizing ‘min’ may be determined by calculating an extreme value that causes a partial differentiation of ‘min’ for Vx and Vy to be 0. For example, when s1 to s6 are expressed as Equation 25 below, the values of Vx(i,j) and Vy(i,j) may be calculated as Vx(i,j)=det1/det and Vy(i,j)=det2/det. Herein, det1=s3*s5−s2*s6, det2=s1*s6−s3*s4, det=s1*s5−s2*s4.

$$s 1 = {\sum }_{{Ω}_{i , j}} {( GradX 0 ( i , j ) + GradX 1 ( i , j ) )}^{2} + α * {( GradX 0 ( i , j ) + GradX 1 ( i , j ) )}^{2} \\ s 2 = s 4 = {\sum }_{{Ω}_{i , j}} ( GradX 0 ( i , j ) + GradX 1 ( i , j ) ) ( GradY 0 ( i , j ) + d \cdot GradY 1 ( i , j ) ) + α * {( GradX 0 ( i , j ) - GradX 1 ( i , j ) )}^{2} {( GradY 0 ( i , j ) - Grad 1 ( i , j ) )}^{2} \\ s 3 = - {\sum }_{{Ω}_{i , j}} ( P 0 ( i , j ) - P 1 ( i , j ) ) ( GradX 0 ( i , j ) + GradX 1 ( i , j ) ) ) + α * ( {P}_{BL} ( i , j ) - 0.5 * ( P 0 ( i , j ) + P 1 ( i , j ) ) ) ( GradX 0 ( i , j ) - GradX 1 ( i , j ) ) \\ s 5 = {\sum }_{{Ω}_{i , j}} {( GradY 0 ( i , j ) + GradY 1 ( i , j ) )}^{2} + α * {( GradY 0 ( i , j ) - GradY 1 ( i , j ) )}^{2} \\ s 6 = - {\sum }_{{Ω}_{i , j}} ( P 0 ( i , j ) - P 1 ( i , j ) ) ( GradY 0 ( i , j ) + GradY 1 ( i , j ) ) + α * ( {P}_{BL} ( i , j ) - 0.5 * ( P 0 ( i , j ) + P 1 ( i , j ) ) ) ( GradY 0 ( i , j ) - GradY 1 ( i , j ) ) i , j ) \qquad Equation 25$$

Instead of using Vx(i,j)=det1/det and Vy(i,j)=det2/det, the horizontal displacement vector Vx(i,j) and the vertical displacement vector Vy(i,j) for the current pixel of the (i,j) position may use an approximated value as an equation Vx(i,j)=s3/s1, Vy(i,j)=(s6−Vx*s2)/s4.

Without acquiring Vx and Vy for minimizing the ‘min’ value, the pixel-unit motion compensation unit 1920 may use the displacement motion vector of each pixel of the corresponding block of the base layer as the displacement motion vector of each pixel of the current block of the upper layer. That is, when the horizontal displacement vector Vx and the vertical displacement vector Vy are determined in the corresponding block of the base layer, the displacement motion vector of the corresponding block of the base layer may be used as the displacement motion vector of the pixel of the enhancement layer without a separate operation process.

When the displacement motion vector of each pixel of the current block of the enhancement layer is determined, the second prediction value P_{BIO} is acquired by calculating the sum or the weighted sum of the block-unit bidirectional motion compensation prediction value and the pixel-unit bidirectional motion compensation prediction value by using the displacement motion vectors and the horizontal and vertical gradient values of the corresponding pixels of the reference picture acquired from the reference pictures of the enhancement layer, as expressed in Equation 23.

The prediction value generating unit 1930 acquires the prediction value of each pixel constituting the current block of the enhancement layer by using the weighted sum of the first prediction value P_{BL} and the second prediction value P_{BIO}, as expressed in Equation 26 below.

p=α*P_{BIO}+(1−α)*P_{BL} Equation 26

When the variance of the pixels in the current block of the enhancement layer is σ1 and the variance of the pixels in the corresponding block of the base layer is σ2, the predetermined weight α may be acquired as Equation 27 below.

$$α = \frac{1}{1 + \frac{σ 1}{σ 2}} \qquad Equation 27$$

Without separately calculating a variance value, a predetermined real value between [0.5, 0.95] may be used as the predetermined weight α.

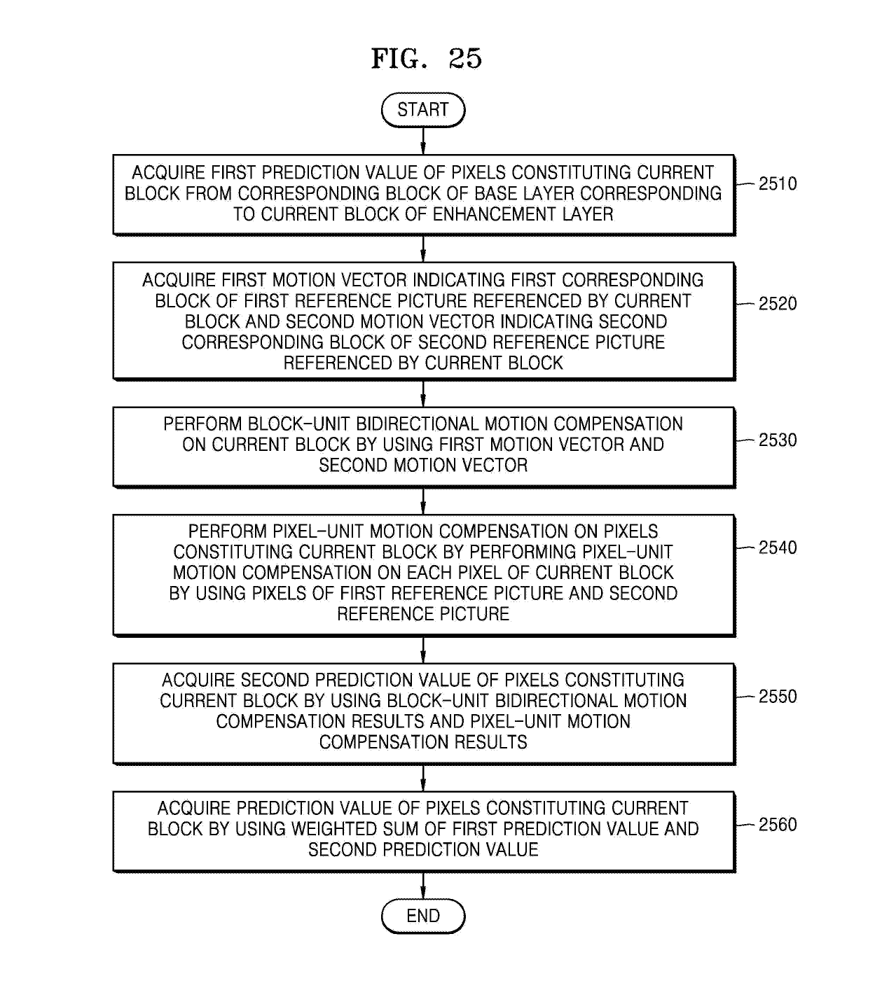

FIG. 25 is a flowchart illustrating a motion compensation method for scalable video encoding and decoding according to an exemplary embodiment.

Referring to FIGS. 19 and 25, in operation 2510, the lower-layer prediction information acquiring unit 1905 acquires a first prediction value P_{BL} of the pixels constituting the current block from the corresponding block of the lower layer corresponding to the current block of the upper layer.

In operation 2520, the block-unit motion compensation unit 1910 acquires a first motion vector indicating the first corresponding block of the first reference picture of the enhancement layer referenced by the current block of the enhancement layer and a second motion vector indicating the second corresponding block of the second reference picture of the enhancement layer. In operation 2530, the block-unit motion compensation unit 1910 performs block-unit bidirectional motion compensation on the current block of the enhancement layer by using the first motion vector and the second motion vector.

In operation 2540, the pixel-unit motion compensation unit 1920 performs pixel-unit motion compensation on each pixel of current block by using the pixels of the first reference picture and the second reference picture. As described above, the pixel-unit motion compensation unit 1920 calculates a variation of the pixel value between the sub-pixels located in the horizontal and vertical directions around the corresponding pixel of the reference pictures of the enhancement layer or uses a predetermined filter around the corresponding pixel of the reference picture to acquire a horizontal gradient value GradX0(i,j) of the first corresponding pixel, a vertical gradient value GradY0(i,j), a horizontal gradient value GradX1(i,j) of the second corresponding pixel, and a vertical gradient value GradY1(i,j). Then, as expressed in Equation 24, the pixel-unit motion compensation unit 1920 determines displacement motion vectors Vx and Vy for minimizing a value (min) that is obtained by adding a square sum of a difference value Δij between a first displacement corresponding pixel PA and a second displacement corresponding pixel PB corresponding to the current pixel P(i,j) of the enhancement layer in a window (Ωij) region of a predetermined size and a value obtained by multiplying the square value of the difference value between the first prediction value P_{BL} and the second prediction value P_{BIO} by a predetermined weight α.

In operation 2550, as expressed in Equation 23, the pixel-unit motion compensation unit 1920 acquires the second prediction value P_{BIO} by using a weighted sum or an addition value of a block-unit bidirectional motion compensation prediction value (P0+P1)/2 and a pixel-unit bidirectional motion compensation prediction value (Vx*(GradX0(i,j)−GradX1(i,j))+Vy*(GradY0(i,j)−GradY1(i,j)))/2.

In operation 2560, as expressed in Equation 26, the prediction value generating unit 1930 acquires the final bidirectional motion compensation prediction value of each pixel constituting the current block of the enhancement layer by using the weighted sum of the first prediction value P_{BL} and the second prediction value P_{BIO}.

According to one or more exemplary embodiments, accurate bidirectional motion compensation may be performed on a pixel-by-pixel basis without a great increase in the bit rate required to encode the motion information.

The inventive concept may also be embodied as computer-readable codes on a computer-readable recording medium. The computer-readable recording medium may be any data storage device that may store data which may be thereafter read by a computer system. Examples of the computer-readable recording medium may include ROMs, RAMs, CD-ROMs, magnetic tapes, floppy disks, and optical data storages. The computer-readable recording medium may also be distributed over network-coupled computer systems so that the computer-readable codes may be stored and executed in a distributed fashion.

Up to now, the inventive concept has been particularly described with reference to exemplary embodiments thereof. However, those of ordinary skill in the art will understand that various changes in form and details may be made in one or more exemplary embodiments without departing from the spirit and scope of the inventive concept. Therefore, the scope of the inventive concept is defined not by the detailed description of exemplary embodiments, but by the appended claims, and all differences within the scope will be construed as being included in the inventive concept.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more units or components of the above-described apparatuses can include circuitry, a processor, a microprocessor, etc., and may execute a computer program stored in a computer-readable medium.

While exemplary embodiments have been particularly shown and described above, it will be understood that various changes in form and details may be made therein without departing from the spirit and scope of the following claims.

1. A motion compensation method for encoding and decoding a scalable video, the motion compensation method comprising:
acquiring a first prediction value of pixels constituting a current block from a corresponding block of a base layer corresponding to the current block of an enhancement layer;
acquiring a first motion vector indicating a first corresponding block of a first reference picture referenced by the current block and a second motion vector indicating a second corresponding block of a second reference picture referenced by the current block;
performing block-unit bidirectional motion compensation on the current block by using the first motion vector and the second motion vector;
performing pixel-unit motion compensation on each pixel of the current block by using pixels of the first reference picture and the second reference picture;
acquiring a second prediction value of the pixels constituting the current block by using block-unit bidirectional motion compensation results and pixel-unit motion compensation results; and
acquiring a prediction value of the pixels constituting the current block by using a weighted sum of the first prediction value and the second prediction value.

2. The motion compensation method of claim 1, wherein the performing of the pixel-unit motion compensation comprises:
determining a horizontal displacement vector and a vertical displacement vector of each pixel of the current block by using horizontal and vertical gradient values of a first corresponding pixel of the first reference picture corresponding to each pixel of the current block, horizontal and vertical gradient values of a second corresponding pixel of the second reference picture corresponding to each pixel of the current block, the pixels of the first reference picture and the second reference picture, and the corresponding block of the base layer; and
generating a pixel-unit motion compensation prediction value of each pixel of the current block by using the horizontal and vertical gradient values of the first corresponding pixel, the horizontal and vertical gradient values of the second corresponding pixel, the determined horizontal displacement vector, and the determined vertical displacement vector.

3. The motion compensation method of claim 2, wherein the horizontal displacement vector and the vertical displacement vector are determined as horizontal and vertical displacement vectors for minimizing a square sum of a first difference value between a first displacement value, which is obtained by displacing the first corresponding pixel of the first reference picture in a window region of a predetermined size by using the horizontal displacement vector, the vertical displacement vector, and the horizontal and vertical gradient values of the first corresponding pixel, and a second displacement value, which is obtained by displacing the second corresponding pixel of the second reference picture by using the horizontal displacement vector, the vertical displacement vector, and the horizontal and vertical gradient values of the second corresponding pixel, and a square value of a second difference value between the first prediction value and the second prediction value.

4. The motion compensation method of claim 3, wherein
when a position of a current pixel of the current block is (i,j) where i and j are integers, a pixel value of the first corresponding pixel of the first reference picture corresponding to the current pixel of the current block is P0(i,j), a pixel value of the second corresponding pixel of the second reference picture corresponding to the current pixel is P1(i,j), the horizontal gradient value of the first corresponding pixel is GradX0(i,j), the vertical gradient value of the first corresponding pixel is GradY0(i,j), the horizontal gradient value of the second corresponding pixel is GradX1(i,j), the vertical gradient value of the second corresponding pixel is GradY1(i,j), the first prediction value of the current pixel of the position (i,j) is P_{BL}(i,j), the second prediction value of the current pixel of the position (i,j) is P_{BIO}(i,j), the horizontal displacement vector is Vx, and the vertical displacement vector is Vy,
the first displacement value has a value of an equation P0(i,j)+Vx*GradX0(i,j)+Vy*GradY0(i,j),
the second displacement value has a value of an equation P1(i,j)−Vx*GradX1(i,j)−Vy*GradY1(i,j), and
the horizontal and vertical displacement vectors are determined as values of Vx and Vy for minimizing a value of an equation
$${\sum }_{{i}^{′} , {j}^{′} ∈ {Ω}_{i , j}} {Δ}_{{i}^{′} {j}^{′}}^{2} + {α ( {P}_{BIO} - {P}_{BL} )}^{2}$$
that is obtained by adding a square sum of a difference Δij between the first displacement value and the second displacement value of the pixels of the current block in a predetermined window Ωij and a value that is obtained by multiplying the square value of the second difference value between the first prediction value and the second prediction value by a predetermined weight α where α is a real number.

5. The motion compensation method of claim 4, wherein
when s1 to s6 are values calculated as equations
$$s 1 = {\sum }_{{Ω}_{i , j}} {( GradX 0 ( i , j ) + GradX 1 ( i , j ) )}^{2} + α * {( GradX 0 ( i , j ) - GradX 1 ( i , j ) )}^{2} \\ s 2 = s 4 = {\sum }_{{Ω}_{i , j}} GradX 0 ( i , j ) + GradX 1 ( i , j ) ) ( GradY 0 ( i , j ) + GradY 1 ( i , j ) ) + α * ( GradX 0 ( i , j ) - GradX 1 ( i , j ) ) ( GradY 0 ( i , j ) - GradY 1 ( i , j ) ) \\ s 3 = - {\sum }_{{Ω}_{i , j}} ( P 0 ( i , j ) - P 1 ( i , j ) ) ( GradX 0 ( i , j ) + GradX 1 ( i , j ) ) ) + α * ( {P}_{BL} ( i , j ) - 0.5 * ( P 0 ( i , j ) + P 1 ( i , j ) ) ) ( GradX 0 ( i , j ) - GradX 1 ( i , j ) ) \\ s 5 = {\sum }_{{Ω}_{i , j}} {( GradY 0 ( i , j ) + GradY 1 ( i , j ) )}^{2} + α * {( GradY 0 ( i , j ) - GradY 1 ( i , j ) )}^{2} \\ s 6 = - {\sum }_{{Ω}_{i , j}} ( P 0 ( i , j ) - P 1 ( i , j ) ) ( GradY 0 ( i , j ) + GradY 1 ( i , j ) ) + α * ( {P}_{BL} ( i , j ) - 0.5 * ( P 0 ( i , j ) + P 1 ( i , j ) ) ) ( GradY 0 ( i , j ) - GradY 1 ( i , j ) ) i , j ) ,$$
and det1, det2, and det are calculated as det1=s3*s5−s2*s6, det2=s1*s6−s3*s4, and det=s1*s5−s2*s4,
a horizontal displacement vector Vx(i,j) for the current pixel of the position (i,j) has a value of an equation Vx(i,j)=det1/det, and a vertical displacement vector Vy(i,j) for the current pixel of the position (i,j) has a value of an equation Vy(i,j)=det2/det.

6. The motion compensation method of claim 5, wherein the horizontal displacement vector Vx(i,j) for the current pixel of the position (i,j) has an approximated value of an equation Vx(i,j)=s3/s1, and the vertical displacement vector Vy(i,j) for the current pixel of the position (i,j) has an approximated value of an equation Vy(i,j)=(s6−Vx*s2)/s4.

7. The motion compensation method of claim 2, wherein the horizontal and vertical gradient values are acquired by using a variation of a pixel value of sub-pixels in horizontal and vertical directions with respect to the first corresponding pixel and the second corresponding pixel.

8. The motion compensation method of claim 1, wherein the first prediction value is acquired by up-sampling a prediction value of the corresponding block of the base layer.

9. The motion compensation method of claim 1, wherein
in the acquiring of the second prediction value,
when a second prediction value for a pixel of a position (i,j) of the current block is P_{BIO}(i,j), a pixel value of a first corresponding pixel of the first reference pixel corresponding to the pixel of the position (i,j) of the current block is P0(i,j), a pixel value of a first corresponding pixel of the first reference pixel corresponding to the pixel of the position (i,j) of the current block is P0(i,j), a horizontal gradient value of the first corresponding pixel of the first reference pixel is GradX0(i,j), a vertical gradient value of the first corresponding pixel of the first reference pixel is GradY0(i,j), a pixel value of a second corresponding pixel of the second reference pixel corresponding to the pixel of the position (i,j) of the current block is P1(i,j), a horizontal gradient value of the second corresponding pixel of the second reference pixel is GradX1(i,j), a vertical gradient value of the second corresponding pixel of the second reference pixel is GradY1(i,j), a horizontal displacement vector is Vx, and a vertical displacement vector is Vy,
a block-unit bidirectional motion compensation prediction value is acquired by an equation (P0(i,j)+P1(i,j))/2,
a pixel-unit motion compensation prediction value is acquired by an equation (Vx*(GradX0(i,j)−GradX1(i,j))+Vy*(GradY0(i,j)−GradY1(i,j)))/2, and
when a predetermined weight is a where a is a real number, the second prediction value P_{BIO}(i,j) for the pixel of the position (i,j) of the current block is acquired by an equation P_{BIO}(i,j)=[P0(i,j)+P1(i,j)+α*(Vx*(GradX0(i,j)−GradX1(i,j))+Vy*(GradY0(i,j)−GradY1(i,j)))]/2.

10. The motion compensation method of claim 1, wherein
when the first prediction value is P_{BL}, the second prediction value is P_{BIO}, and a predetermined weight is α where α is a real number,
the prediction value p of the pixels constituting the current block is acquired by an equation p=α* P_{BIO}+(1−α)* P_{BL}.

11. A motion compensation device for encoding and decoding a scalable video, the motion compensation device comprising:
a lower-layer prediction information acquiring unit configured to acquire a first prediction value of pixels constituting a current block from a corresponding block of a base layer corresponding to the current block of an enhancement layer;
a block-unit motion compensation unit configured to acquire a first motion vector indicating a first corresponding block of a first reference picture referenced by the current block and a second motion vector indicating a second corresponding block of a second reference picture referenced by the current block and perform block-unit bidirectional motion compensation on the current block by using the first motion vector and the second motion vector;
a pixel-unit motion compensation unit configured to perform pixel-unit motion compensation on each pixel of the current block by using pixels of the first reference picture and the second reference picture and acquire a second prediction value of the pixels constituting the current block by using the block-unit bidirectional motion compensation results and the pixel-unit motion compensation results; and
a prediction value generating unit configured to acquire a prediction value of the pixels constituting the current block by using a weighted sum of the first prediction value and the second prediction value.

12. The motion compensation device of claim 11, wherein the pixel-unit motion compensation unit determines a horizontal displacement vector and a vertical displacement vector of each pixel of the current block by using horizontal and vertical gradient values of a first corresponding pixel of the first reference picture corresponding to each pixel of the current block, horizontal and vertical gradient values of a second corresponding pixel of the second reference picture corresponding to each pixel of the current block, the pixels of the first reference picture and the second reference picture, and the corresponding block of the base layer, and generates a pixel-unit motion compensation prediction value of each pixel of the current block by using the horizontal and vertical gradient values of the first corresponding pixel, the horizontal and vertical gradient values of the second corresponding pixel, the determined horizontal displacement vector, and the determined vertical displacement vector.

13. The motion compensation device of claim 12, wherein the horizontal displacement vector and the vertical displacement vector are determined as horizontal and vertical displacement vectors for minimizing a square sum of a first difference value between a first displacement value, which is obtained by displacing the first corresponding pixel of the first reference picture in a window region of a predetermined size by using the horizontal displacement vector, the vertical displacement vector, and the horizontal and vertical gradient values of the first corresponding pixel, and a second displacement value, which is obtained by displacing the second corresponding pixel of the second reference picture by using the horizontal displacement vector, the vertical displacement vector, and the horizontal and vertical gradient values of the second corresponding pixel, and a square value of a second difference value between the first prediction value and the second prediction value.

14. The motion compensation device of claim 13, wherein
when a position of a current pixel of the current block is (i,j) where i and j are integers, a pixel value of the first corresponding pixel of the first reference picture corresponding to the current pixel of the current block is P0(i,j), a pixel value of the second corresponding pixel of the second reference picture corresponding to the current pixel is P1(i,j), the horizontal gradient value of the first corresponding pixel is GradX0(i,j), the vertical gradient value of the first corresponding pixel is GradY0(i,j), the horizontal gradient value of the second corresponding pixel is GradX1(i,j), the vertical gradient value of the second corresponding pixel is GradY1(i,j), the first prediction value of the current pixel of the position (i,j) is P_{BL}(i,j), the second prediction value of the current pixel of the position (i,j) is P_{BIO}(i,j), the horizontal displacement vector is Vx, and the vertical displacement vector is Vy,
the first displacement value has a value of an equation P0(i,j)+Vx*GradX0(i,j)+Vy*GradY0(i,j),
the second displacement value has a value of an equation P1(i,j)−Vx*GradX1(i,j)−Vy*GradY1(i,j), and
the horizontal and vertical displacement vectors are determined as values of Vx and Vy for minimizing a value of an equation
$${\sum }_{{i}^{′} , {j}^{′} ∈ {Ω}_{i , j}} {Δ}_{{i}^{′} {j}^{′}}^{2} + {α ( {P}_{BIO} - {P}_{BL} )}^{2}$$
that is obtained by adding a square sum of a difference Δij between the first displacement value and the second displacement value of the pixels of the current block in a predetermined window Ωij and a value that is obtained by multiplying the square value of the second difference value between the first prediction value and the second prediction value by a predetermined weight a where a is a real number.

15. The motion compensation device of claim 14, wherein
when s1 to s6 are values calculated as equations, and det1, det2, and det are calculated as det1=s3*s5−s2*s6, det2=s1*s6−s3*s4, and det=s1*s5−s2*s4,
a horizontal displacement vector Vx(i,j) for the current pixel of the position (i,j) has a value of an equation Vx(i,j)=det1/det, and a vertical displacement vector Vy(i,j) for the current pixel of the position (i,j) has a value of an equation Vy(i,j)=det2/det.
